(19) United States
(12) Patent Application Publication
(10) Pub. No.: US 2005/0053364 A1
(43) Pub. Date: Mar. 10, 2005

(54) Optical disk device, optical disk reproducing method, and optical disk

(75) Inventor: Koichi Nagai, Chigasaki-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/926,290

(22) Filed: Aug. 26, 2004

(30) Foreign Application Priority Data
Aug. 26, 2003 (JP) 2003-301993

(51) Int. Cl. H04N 5/781

(52) U.S. Cl. 386/125; 386/126

(57) ABSTRACT

An optical disk device for reproducing an optical disk having recorded therein a plurality of data to be read at no lower than a specific reading linear speed discretely at a predetermined interval or less, the optical disk device comprises means for determining any one of a minimum value of a disk rotating speed demanded at the current reading position and a minimum value of a disk rotating speed demanded at a second position remote from the current reading position by a predetermined distance, whichever the greater, and target speed setting means for setting the rotating speed greater than the minimum value determined by the determining means as a target rotating speed at the current reading position.

### CROSS-REFERENCE TO RELATED APPLICATIONS

This application is based upon and claims the benefit of priority from prior Japanese Patent Application No. 2003-301993, filed Aug. 26, 2003, the entire contents of which are incorporated herein by reference.

### BACKGROUND OF THE INVENTION

1. Field of the Invention

The present invention relates to an optical disk device such as DVD (digital video disk or digital versatile disk) player, a DVD-ROM drive or a DVD recorder, an optical disk reproducing method, and an optical disk.

2. Description of the Related Art

Recently, optical disks which encode video, audio, sub-picture and the like to record at high density are developed. When recording information such as movie in such an optical disk, it may be possible to record story data of a plurality of stories progressing simultaneously. Also when recording information such as movie in such an optical disk, it may be considered to record multi-angle scenes obtained by taking the same event progressing simultaneously from a plurality of angles.

For a producer of an optical disk, there are several choices: when desired to combine first and second stories and present to viewers; when desired to present the first story mainly to the viewers; when desired to present the second story mainly to the viewers; and the like. However, in the conventional movie production, there has been only once choice in production. It holds same in the case of first and second scenes, too. By contrast, if the viewer can freely choose which one to see first story or second story, or first scene or second scene, the producer will have a greater freedom in production.

Among optical disk recording apparatuses developed recently, when recording information such as movie, by preliminarily recording plural stories or plural scenes progressing simultaneously, the viewers are allowed to select freely from them at the time of reproduction.

Accordingly, when recording data of plural stories or scenes in an optical disk, it is preferred to record so that data can be handled easily when reproducing. For example, suppose that story data of first and second stories are recorded in series. When desired to reproduce only one story at the time of reproduction, it is required to jump to a recording area of the other story. If the other story is short in time, the physical moving distance of the pickup is short, and there is no problem. However, if the other story is long in time, the physical moving distance of the pickup is long, so that the reproduced image may be interrupted or disturbed.

By properly designing the recording structure of interleaved blocks such as multi-scenes, and devising the reproducing processing method, it has been proposed to provide a disk recording apparatus and method capable of lessening the load of the hardware and increasing the number of streams easily (for example, see Japanese Patent No. 2,857,119 (refer to paragraphs 0094 to 0110, and FIGS. 22 to 24).

This apparatus is a recording apparatus for reproducing a recording medium comprising a data region storing data to be decoded, and management data region storing management data necessary for reproducing the recorded data in the data region. The data region includes control data, and has an interleaved block portion in which video signals of plural scenes are distributed and stored in plural interleaved units, and interleaved units of each scene are mixed and arranged on recording tracks. The control data is included in each interleaved unit, and information indicative of mixture of the interleaved unit and a logical address of next interleaved unit as the destination of next jump for each scene are described in the recording medium. Means for controlling the system includes: means for, every time when the interleave unit is reproduced, reading control data belonging to the interleaved unit, and recognizing the information indicative of mixture of the interleaved unit and the logical address of next interleaved unit for each scene as the destination of next jump for each scene; and means for controlling a reading position of data of the recording medium in order to change a reproduction stream of the interleaved unit by referring to the logical address of next interleaved unit for each scene included in the control data when operation information for scene changeover, whereby the jump destination of next interleaved unit for each scene is newly recognized from the control data belonging to the interleaved unit acquired at the reading position, thereby waiting for scene changeover. By these means, management of scene changeover is easier, and the load of the hardware is lessened, so that the recording apparatus can be designed easily and manufactured at low cost.

Usually, a data reading rate from an ECC (error check and correction) processing unit is almost constant, but since video data is recorded in a variable rate system, the reading rate demanded by the decoder varies depending on the content of the picture. In the case of multi-scene recording, data is not recorded continuously on the disk but is recorded intermittently, and hence data reading is not continuous, but the decoder demands data continuously. To absorb this difference, reproduction data from the ECC processing unit is once stored in a track buffer, the output of the track buffer is supplied to the decoder, and the size of the interleaved unit is determined so as to satisfy the condition that the data is continuously output from the track buffer, that is, the data is supplied to the decoder without interruption. The size of the track buffer is determined such that the memory output data is not interrupted even if the recording apparatus kicks back, and successively jumps an interleaved unit. The kick-back process is a process of reading data again for a portion of predetermined sectors already being read out, and it is function for compensating for data missing even if data overflows in the track buffer.

The DVD standard employing this technology is widely distributed and highly evaluated (for example, refer to Standard ECMA-267 120 mm DVD-Read-Only Disk, 3rd Edition, April 2001). Recently, household displays applicable to high definition (HD) images are spreading, and information recording media are also designed to be applicable to high definition (HD) images. In the existing DVD-Video standard, a movie of standard definition (SD) with standard duration can be recorded in a one-layer DVD-ROM. Owing to the recent progress in moving picture compression technology, high definition (HD) images of about four times of pixels can be compressed to about double data quantity in average, and hence a movie can be recorded in a two-layer DVD-ROM. That is, the data quantity is double in average, but is triple in part. Therefore, the data rate Vo to be supplied from the track buffer to the decoder is 3 times of the conventional rate, and the required data rate Vr being read out from the disk and supplied to the track buffer is also 3 times of the conventional rate. In the existing DVD-Video standard, moreover, the data rate Vo in the multi-scene section is set at a smaller value than in sections other than the multi-scene section, but from the viewpoint of the image quality, it is desired to increase the data rate Vo. When the data rate Vo is greater, the size of the interleaved unit is larger, and the jumping distance must be longer.

Incidentally, in many optical disks including a DVD-ROM, since the linear recording density is constant, it is required to vary the rotating speed by the radius in order to read out information at a constant data rate Vr. As a rotation control system for an optical disk, a CLV (constant linear velocity) system is employed in a DVD-ROM, and a ZCLV (zoned constant linear velocity) system is employed in a DVD-RAM. In the CLV system, the rotating speed is changed (faster at the inner side) depending on the radius such that the linear speed of recording/reproduction is constant on the entire disk surface, and the entire disk surface is recorded/reproduced at constant linear recording density, so that the recording capacity is assured. The recording/reproduction frequency is also constant. In the ZCLV system, a disk is divided into doughnut-shaped recording regions (zones) in the radial direction, and the rotating speed is constant in each zone (CAV (constant angular velocity) system), and the number of sectors per track in each zone is increased toward the outer side. That is, the rotating speed is constant within a zone, but differs among zones. The rotating speed is low in outer zones. However, the linear speed is almost constant in the entire disk surface.

Change of the rotating speed by radius can be realized by controlling a spindle motor. When the torque of the spindle motor is constant, the time required for changing the rotating speed in the same radius is nearly proportional to the data rate Vr and jump distance. Actually, as general characteristics of a motor, as the rotating speed increases, the viscous resistance and wind loss increase, and therefore as the rotating speed becomes faster, the available torque usable for acceleration or deceleration of the disk rotating speed is decreased.

In the existing DVD-Video standard, the disk rotating speed could be followed up until end of jump (the required follow-up time being about tens of milliseconds). When demanded to increase the disk rotating speed three times and extend the jump distance, however, it is hard to increase the torque of the spindle motor. Therefore, even if the jump is over, it is hard to keep the linear speed, that is, the reading rate of data. In portable appliances, in particular, the available peak electric power is limited because of battery operation. To increase the peak electric power, the battery size must be increased, which leads to increase in size and weight of the apparatus, possibly spoiling the commercial value. It is hence not realistic to increase the motor torque.

When reproducing a two-layer disk, in the case of jumping from the outer circumference to the inner circumference, the disk rotating speed must be increased. However, if failing to follow up due to lack of torque, the data rate Vr is lower than the assumed reference value, so that the track buffer may be empty and the image reproduction may be interrupted. In particular, since the data quantity is large in high definition video, a two-layer disk is widely used, and this is a serious problem.

In some of the current DVD-ROM drives capable of reproducing at high speed, the CAV system for rotating at constant rotating speed the disk recorded at constant linear speed is employed instead of the CLV system for rotating at constant linear speed. In this case, since the reading data rate Vr is kept over 3 times, if the inner circumference is set at 3 times, the linear speed of the outermost circumference is about 7.3 times. If this system can be employed, the above problem can be solved.

However, the guaranteed reading rate even in, for example, a current DVD-ROM standard is an equal speed, and disk warp, eccentricity and other mechanical properties are determined by assuming an equal speed reproduction. If the disk is warped or eccentric, the objective lens actuator must generate a force to follow up, but since the acceleration caused by distortion or eccentricity is proportional to a square of linear speed, in the case of 8× variable-speed, for example, a force of 64 times is required as compared with an equal speed. It is actually difficult to generate such a large force. Therefore, even in the case of the drive capable of reproducing at high speed, since high speed reproduction is difficult depending on mechanical properties such as warp of the disk, the reproduction speed is lowered in such a case. That is, if the warp or eccentricity of the disk is sufficiently smaller as compared with the standard, high speed reproduction may be possible, but when large, it is impossible to follow up. Accordingly, it is forced to lower the reproduction speed.

In a disk capable of recording high definition (HD) video, maximum values of disk warp and eccentricity must be determined in order to reproduce at 3× variable-speed. However, considering the current disk manufacturing technology, such as aging effects, cost, and performance and cost of the optical disk recording apparatus, it is not realistic to determine the standard allowing reproduction in the CAV system of 3× variable-speed at the innermost circumference, and the problem cannot be solved by reproducing in the CAV system.

Thus, in the conventional optical drive device applicable to HD images, it is required to raise the disk rotating speed, and it is hard to keep constant the reading rate from the disk and data writing rate into the track buffer. Also in the existing DVD-Video standard, the possible setting maximum value of data rate changes between the multi-scene section and other sections, and picture quality may be different, and therefore, it is also demanded to solve these problems.

### BRIEF SUMMARY OF THE INVENTION

An object of the present invention is to provide an optical disk device, optical disk reproducing method, and optical disk capable of keeping the data reading rate above a constant level.

According to an embodiment of the present invention, an optical disk device for reproducing an optical disk having recorded therein a plurality of data to be read at no lower than a specific reading linear speed discretely at a predetermined interval or less, the optical disk device comprises:
means for determining any one of a minimum value of a disk rotating speed demanded at the current reading position and a minimum value of a disk rotating speed demanded at a second position remote from the current reading position by a predetermined distance, whichever the greater; and
target speed setting means for setting the rotating speed greater than the minimum value determined by the determining means as a target rotating speed at the current reading position.

According to another embodiment of the present invention, an optical disk device for reproducing an optical disk having recorded therein a plurality of data to be read at not lower than a specific reading linear speed discretely at a predetermined interval or less, the optical disk being required to jump the predetermined interval within a predetermined time Tj, the optical disk device comprises:
means for determining any one of a minimum value A of a disk rotating speed demanded at the current reading position and a minimum value B of a disk rotating speed demanded at a second position remote from the current reading position by a predetermined distance, whichever the greater; and
target speed setting means for setting, when the minimum value B is greater, any one of (the minimum value B−motor acceleration AccDisk×Tj) and the rotating speed A, whichever the greater, as a target rotating speed at the current reading position.

Additional objects and advantages of the present invention will be set forth in the description which follows, and in part will be obvious from the description, or may be learned by practice of the present invention.

The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is an explanatory diagram showing an area structure on a DVD-ROM disk of the present invention;

FIG. 2 is an explanatory diagram showing a data structure in a lead-in area of the DVD-ROM disk in FIG. 1;

FIG. 3 is an explanatory diagram of detailed information contents of physical format information in FIG. 2;

FIGS. 4A, 4B and 4C are explanatory diagrams showing a logical sector number setting method of a DVD-ROM (one-layer, two-layer disks);

FIG. 5 is an explanatory diagram showing a volume space of an optical disk;

FIG. 6 is an explanatory diagram showing in more detail a structure of a video manager VMG and a video title set VTS;

FIG. 7 is an explanatory diagram hierarchically showing a relation between a video object set VOBS and a cell CELL, and content of the cell CELL;

FIG. 8 is an explanatory diagram showing an example of controlling the reproduction sequence of cells CELLs by a program chain PGC;

FIG. 9 is an explanatory diagram showing relation between a video object unit VOBU and a video pack in the unit;

FIG. 10 is an explanatory diagram showing an example of arrangement of interleaved blocks;

FIG. 11 is an explanatory diagram showing a recorded state in which video objects of scenes of angle 1 and angle 2 are divided into three interleaved units ILVU1-1 to ILVU3-1 and ILVU1-2 to ILVU3-2 respectively, and arranged on one track, and an example of a reproduction output in the case of reproduction of angle 1;

FIG. 12 is a block diagram of an optical disk reproducing apparatus according to a first embodiment of the invention;

FIG. 13 is an explanatory diagram showing a simplified optical disk reproducing apparatus in FIG. 12;

FIG. 14 is an explanatory diagram showing a recording unit of information to be recorded in a data area;

FIG. 15 is an explanatory diagram showing the worst case of increase and decrease of data input into a track buffer when reproducing interleaved blocks;

FIG. 16 is an explanatory diagram showing time and data reduction status in the track buffer in the case where kick-back operation is performed in a recording apparatus followed immediately by jump operation of maximum distance;

FIG. 17 is a flowchart showing an operation according to the first embodiment of the invention;

FIG. 18 shows an example of change (in schematic view) in reading rate and disk motor rotating speed in the case of jumping in the optical disk device according to the first embodiment of the invention;

FIG. 19 is a diagram showing a range of ratio of spindle motor target rotating speed to standard speed in the optical disk device to which the first embodiment of the invention is applied;

FIG. 20 is a diagram showing a range of spindle motor target rotating speed in the optical disk device to which the first embodiment of the invention is applied;

FIG. 21 is a diagram showing an example of setting the target rotating speed in the first embodiment of the invention;

FIG. 22 is a diagram showing a range of ratio of spindle motor target rotating speed to standard speed in an optical disk device to which a second embodiment of the invention is applied; and

FIG. 23 is a diagram showing a range of the spindle motor target rotating speed in the optical disk device to which the second embodiment of the invention is applied.

### DETAILED DESCRIPTION OF THE INVENTION

An embodiment of an optical disk device, an optical disk recording method, and an optical disk according to the present invention will now be described with reference to the accompanying drawings.

First Embodiment

An optical disk which encodes video, audio, sub-picture and the like to record at high density, and an optical disk device as an apparatus for recording/reproducing the same are developed. When recording information such as a movie in this optical disk, plural stories progressing simultaneously are recorded, or multi-angle scenes obtained by taking the same event progressing simultaneously from a plurality of angles are recorded, and the viewer is allowed to choose a desired scene freely.

First is explained an outline of an optical disk of DVD standard having such functions and presently put in practical use and an apparatus for reproducing such an optical disk.

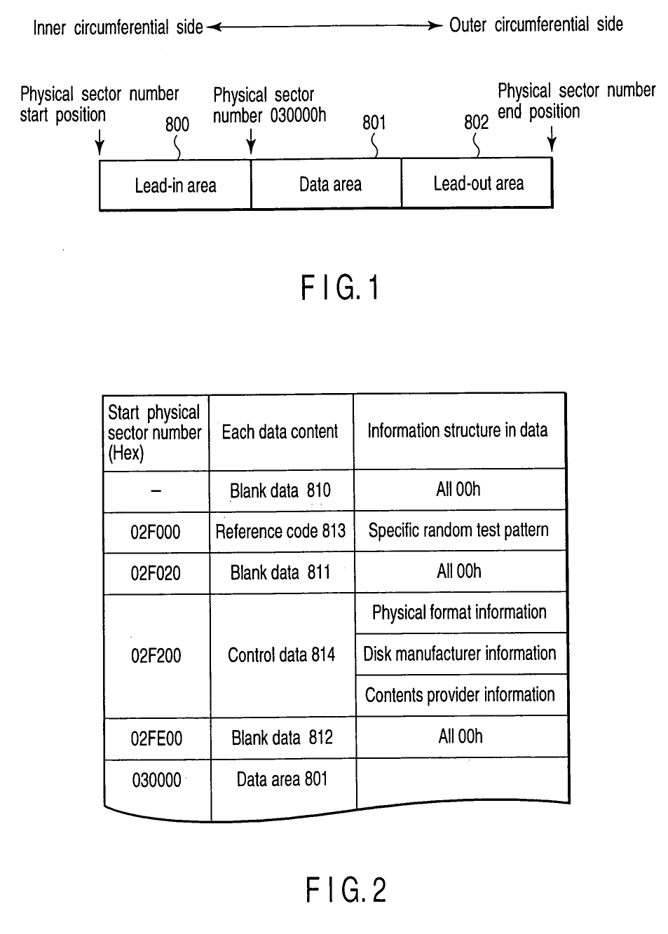

FIG. 1 shows an area structure of a DVD-ROM disk. From the inner circumference to the outer circumference of a circular information storage medium, a lead-in area 800, a data area 801, and a lead-out area 802 are arranged sequentially. In the DVD-ROM disk, information is recorded as blocks of 2048 bytes each, and this minimum recording unit is called a sector. In each sector, a physical sector number is set, and this physical sector number is recorded on a recording surface of the DVD-ROM disk as described below. The physical sector number start position coincides with a start sector of the lead-in area 800 in the innermost circumference of the information storage medium, and as going toward the outer circumference, physical sector numbers consecutive in ascending order are set. The physical sector number of a first sector in the data area 801 is predetermined, that is, 030000h (h denotes hexadecimal notation).

A data structure in the lead-in area 800 of the DVD-ROM disk is shown in FIG. 2. A reference code 813 showing a reference signal and control data 814 are arranged, and blank data 810, 811 and 812 each having 00h recorded therein are present therebetween.

In the reference code 813, a specific random test pattern is recorded, and by using this information, an information recording apparatus can be adjusted, such as adjustment of a parameter of an automatic equalizer. In the control data 814, various data are recorded, including physical format information which is format information intrinsic to the information storage medium as described later, disk manufacturing information including information about manufacture such as serial manufacturing numbers of individual information recording media, and contents provider information showing information about information contents recorded in the data area 801.

The physical sector number of a beginning sector in which the reference code 813 is recorded is 02F000h, and the physical sector number of a beginning sector in which the control data 814 is recorded is 02F200h.

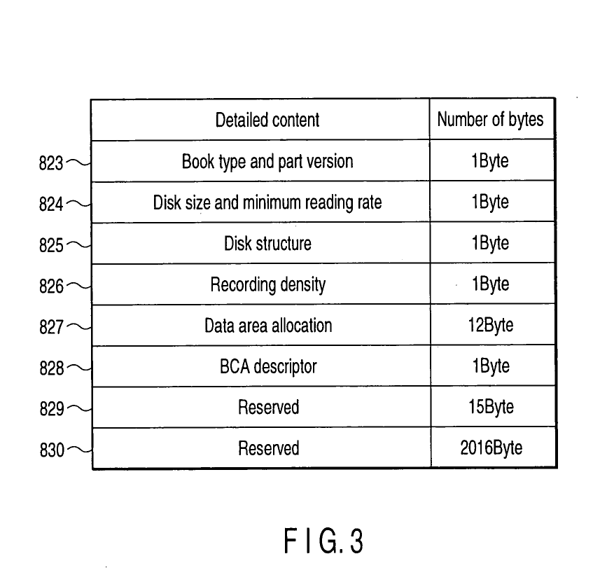

As shown in FIG. 3, the physical format information includes: book type and part version 823 showing the applicable DVD standard type (DVD-ROM, DVD-RAM, DVD-R, etc.) and part version; disk size and minimum read-out rate 824 showing the disk size and minimum read-out rate; disk structure 825 showing a disk structure such as one-layer ROM disk, one-layer RAM disk, and two-layer ROM disk; recording density 826 showing the recording density; data area allocation 827 showing the position at which data is recorded; burst cutting area (BCA) descriptor 828 having serial manufacturing numbers of individual information recording media recorded invariably at the inner circumference of the information storage medium, and reserved areas 829, 830 reserved for future use.

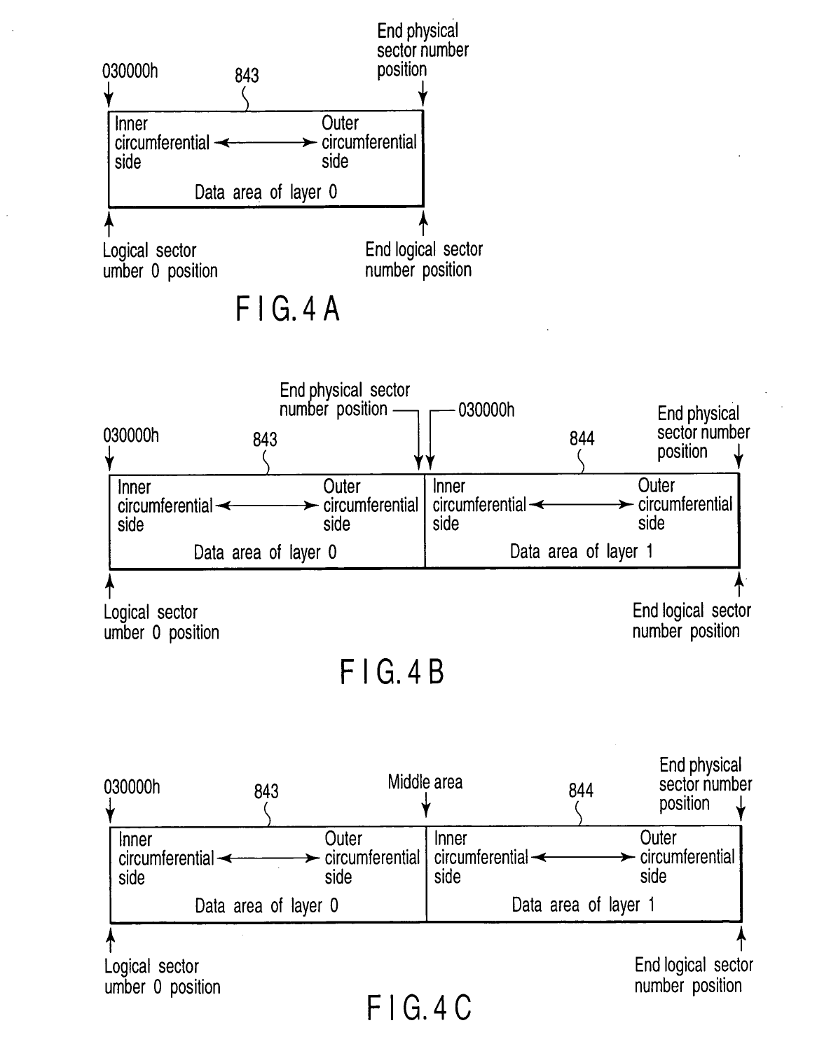

FIGS. 4A, 4B and 4C show logical sector number setting method in a DVD-ROM disk having one-layer structure or two-layer structure. The physical sector number PSN is an address setting method in sector unit in which the sector number is individually set in every layer of a recording surface of an information storage medium (DVD-ROM disk or DVD-RAM disk), and the physical sector number is set on the recording surface. By contrast, the logical sector number LSN corresponds to a method of setting a comprehensive address (address setting in sector unit) by regarding all as one volume space in the information storage medium having a recording surface in one layer or plural layers. The logical sensor number is a systematic number setting method, and unlike the physical sector number, it is not recorded directly on the recording surface of the information storage medium.

FIG. 4A is a diagram explaining a logical sector setting method in a DVD-ROM disk having only one-layer recording surface with the region structure shown in FIG. 1. In FIG. 4A, in the volume space from the lead-in area 800 to the lead-out area 802, the physical sector number PSN and logical sector number LSN correspond to each other by 1:1.

FIGS. 4B and 4C are diagrams explaining a logical sector number setting method in a DVD-ROM disk having a two-layer recording surface with the region structure shown in FIG. 1.

In the volume space integrating two layers shown in FIG. 4B, data area 843 of layer 0 is disposed in the smaller side (first half of volume space) of the physical sector number PSN, and data area 844 of layer 1 is disposed in the larger side (latter half of volume space) of the physical sector number PSN. The setting position of the logical sector number LSN is determined such that the physical sector number 030000h of layer 1 follows consecutively next to the End physical sector number position in the data area 843 of layer 0. As a result, the physical sector number PSN of first half layer 0 and the physical sector number PSN of latter half layer 1 correspond to the logical sector number LSN of a single volume space.

FIG. 4C is a diagram explaining another logical sector number setting method. Same as in the setting method of FIG. 4B, the data area 843 of layer 0 is disposed in the first half of the volume space (=first half of logical sector number), and the data area 844 of layer 1 is disposed in the latter half of the volume space (=latter half of logical sector number). In the setting method in FIG. 4C, however, both layer 0 and layer 1 are different from the configuration in FIG. 1 in the region structure. That is, in layer 0, the position of the lead-out area 802 in FIG. 1 is changed to a middle area 848. In layer 1, the lead-out area 802 is disposed in the position of the lead-in area 800 disposed at the inner circumference in FIG. 1, and the middle area 848 is disposed in the position of the lead-out area 802 disposed at the outer circumference in FIG. 1. Further in layer 1, regardless of the data area 801, lead-out area 802, and middle area 848, the physical sector numbers are set and recorded in the ascending order from the outer circumference to the inner circumference. The logical sector numbers of layer 0 and layer 1 are consecutively connected at the location of the middle area 848 of the both.

In the data area allocation 827 in the physical format information shown in FIG. 3, the End physical sector number of the data area in layer 0 is recorded. The smallest physical sector number at the outermost circumference of the data area in layer 1 is a value obtained by bit-inverting the End physical sector number at the outermost circumference of the data area in layer 0, and is a complement expression of 1, thereby being a negative value. Therefore, the logical sector number can be changed to a physical sector number. If the physical sector number in layer 0 and physical sector number in layer 1 are equal in absolute value, the distance from the disk center to the sector is nearly equal.

In the configuration in FIG. 4C, it is a feature that the ratio of the distance in the logical sector number and the physical sector interval on the disk is constant as compared with FIG. 4B. For example, in the system in FIG. 4B, when moving to the first sector of layer 1 next to the last sector of layer 0 from the last sector of layer 0, that is, moving only one sector, the optical head must be moved from the outermost circumference to the innermost circumference of the disk. On the other hand, in the system in FIG. 4C, the change in the radial position is only within about manufacturing error. This feature is greatly advantageous for preventing extension of necessary rough access (detail described later) and suppressing volume increase of a track buffer as mentioned blow, when recording the information without interrupting the image such as reproduction of movie.

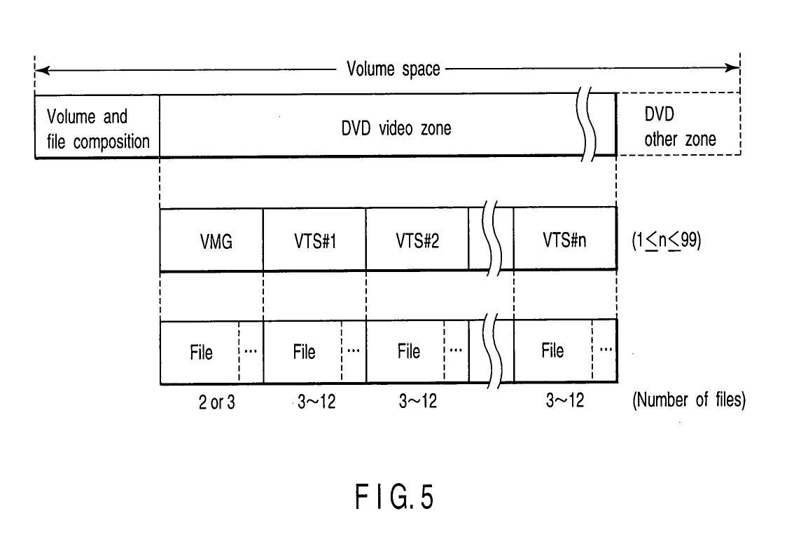

FIG. 5 shows a volume space of a DVD-ROM disk in which video data such as movie is recorded. The volume space is composed of volume and file zone, DVD video zone, and DVD another zone. The volume and file zone describes a bridge composition of UDF (universal disk format specification revision 1.02), and the data can be read even by a computer of specified standard. The DVD video zone includes video manager VMG and n (1 to 99) video title sets VTSs. The video manager VMG and video title set VTS are individually composed of a plurality of files. The video manager VMG is information for controlling the video title set VTS.

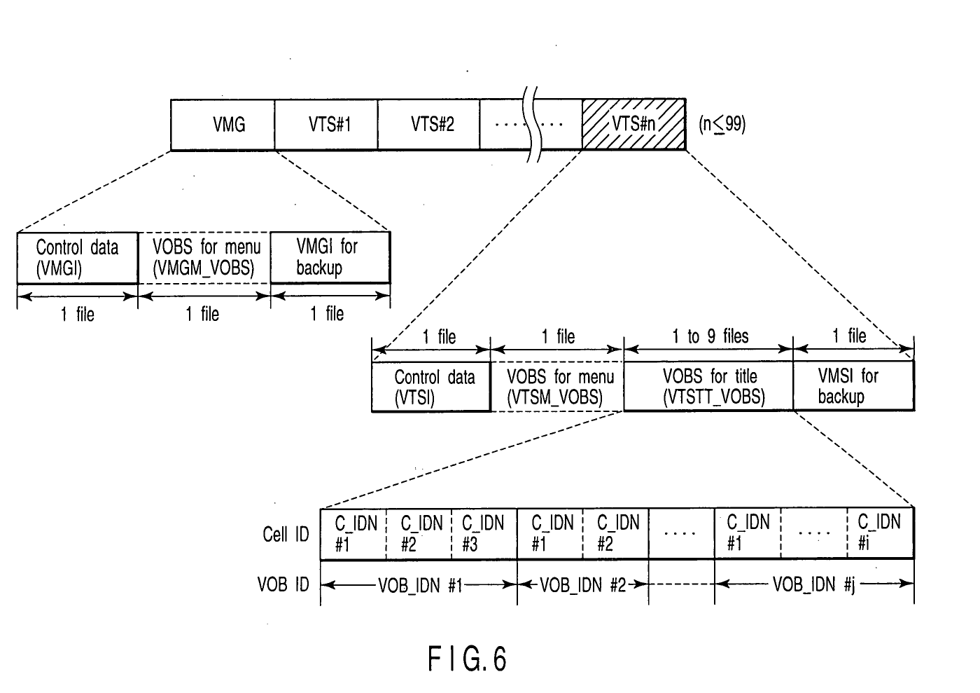

FIG. 6 shows more specifically the structure of the video manager VMG and video title set VTS.

The video manager VMG includes video manager information VMGI as control data, and video object set VMGM_VOSB as data for menu display. It also includes video manager information VMGI for back-up having the same content as the video manager information VMGI.

The video title set VTS includes video title set information VTSI as control data, video object set VTSM_VOSB as data for menu display, and video object set VTSTT_VOBS for title of video title set as the video object set for video display. It also includes video title set information VTSI for back-up having the same content as the video title set information VTSI.

The video object set VTSTT_VOBS for title as video object set for image display is composed of a plurality of cells. Each cell has its own cell ID number.

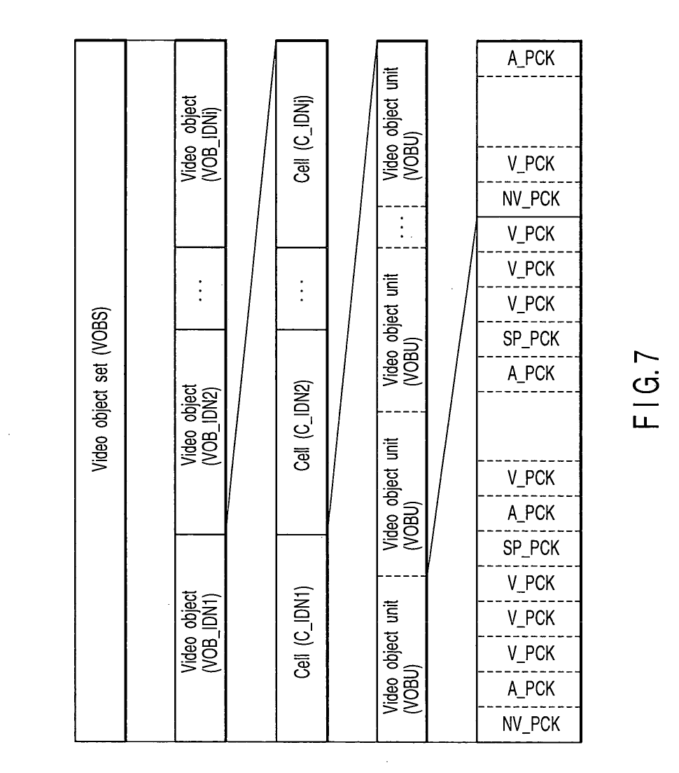

FIG. 7 shows the relation between the video object set VOBS and the cell CELL, and also shows the content of cell hierarchically. When the DVD is reproduced, for image dividing (scene change, angle change, story change, etc.) and special reproduction, it is designed to be handled in units of cell CELL, video object unit VOBU as the lower layer, or interleaved unit ILVU.

A video object set VOBS is composed of plural video objects VOB_IDN1 to VOB_IDNi. One video object VOB is composed of plural cells C_IDN1 to C_IDNj. One cell is composed of plural video object units VOBUs or interleaved objects ILVUs described below. One video object unit VOBU is composed of one navigation pack NV_PCK, plural audio packs A_PCKs, plural video packs V_PCKs, and plural sub-picture packs SP_PCKs.

The navigation pack NV_PCK is used mainly as control data for control of reproduction and display of data in the video object unit VOBU belonging to and control data for data search of the video object unit VOBU. The video pack V_PCK is main video information, and is compressed according the standard such as MPEG-4 or the like. The sub-picture pack SP_PCK is sub-picture information having a subsidiary content to the main video. The audio pack A_PCK is audio information.

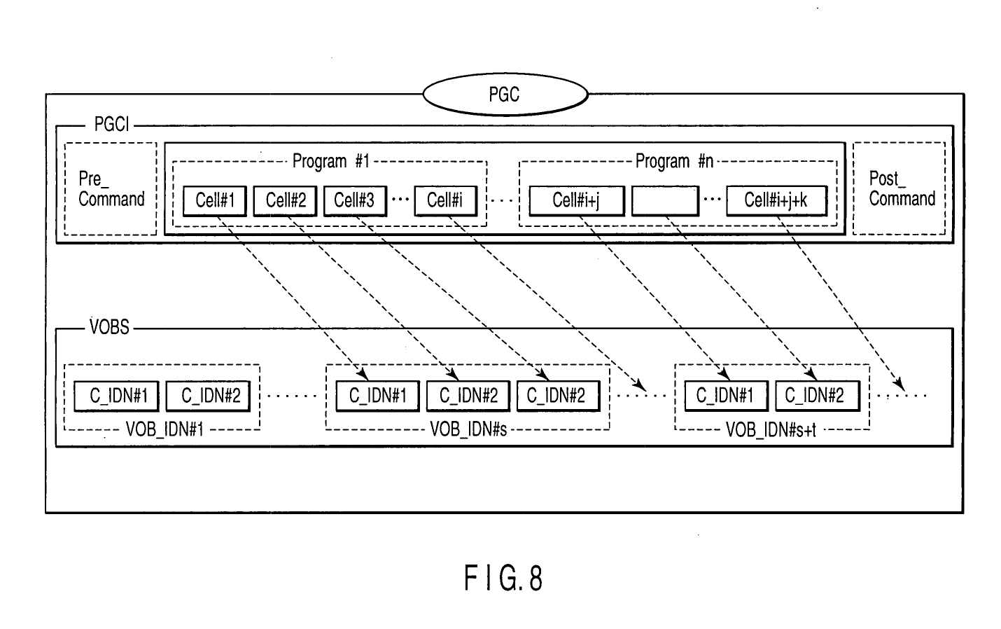

FIG. 8 shows an example in which the reproduction sequence of the plural cells is controlled by program chain PGC.

As the program chain PGC, various program chains PGC#1, PGC#2, PGC#3, . . . are prepared so as to set in various reproduction sequences of data cells. Therefore, by selecting a program chain, the cell reproduction sequence can be set.

This is to show an example of execution of programs #1 to #n described by program chain information PGCI. The shown program specifies sequentially the cells after the cells specified by VOB_IDN#s, C_IDN#1 in the video object set VOBS. The program chain is recorded in a management information recording area of the optical disk, and it is the information that is read prior to reading of video title set of the optical disk and stored in a memory of a system control unit. Management information is disposed at the beginning of the video manager and each video title set.

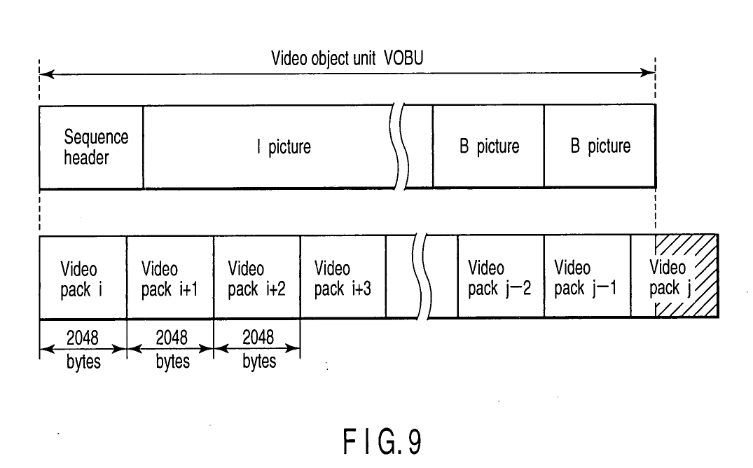

FIG. 9 shows the relation between video object unit VOBU and video pack in the unit. Video data in the video object unit VOBU is composed of one or more groups of pictures GOP. Encoded video data conforms, for example, to ISO/IEC13818-2. The group of pictures GOP in the video object unit VOBU is composed of I picture and B picture, and the continuity of data is divided to form video packs.

Next, a data unit in which multi-angle information is recorded and reproduced will be described. When plural scenes differing in view point with respect to an object are recorded in a disk, to realize a seamless reproduction, an interleaved block portion is composed on a recording track. The interleaved block portion includes plural video objects VOBs differing in angle, and they are divided into individual interleaved units ILVU, and are arranged and recorded so as to realize seamless reproduction. Hereinafter, the interleaved block is called an interleaved unit.

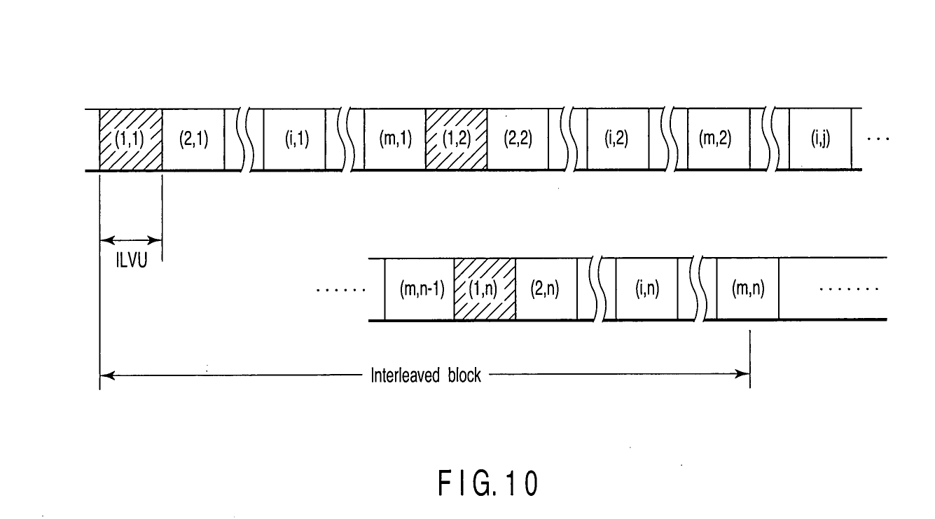

FIG. 10 shows an example of arrangement of interleaved units ILVU. In this example, 1 to m video objects VOBs are respectively divided into n interleaved units ILVU, and arranged. Each video object VOB is divided into the same number of interleaved units ILVUs.

Presentation data is composed of video objects VOBs conforming to the program stream specified in MPEG-2. Video object VOB is composed of video data, audio data, sub-picture data, PCI data, and DSI data. VOB is defined by the following restrictions. (r1) The value of SCR of the beginning pack of each VOB must be set at 0. (r2) VOB as part of the program stream must not be terminated with program_end_code. (r3) VOB disposed in the interleaved block has a certain limited discontinuity in the audio elementary stream.

A storage region for presentation data is called video object set VOBS. Video manager menu, video title set menu, and video title set individually have a single VOB for reproduction.

Video object set VOBS is composed of one or more video object blocks comprising a plurality of video objects. Video object VOB is presentation data, and the VOB block is a method of storing one or more VOBs on a disk.

VOB block is classified in two types depending on the manner of arrangement of video objects in the block. The two types are continuous block and interleaved block.

A continuous block is a block in which a single video object VOB is arranged in consecutive logical sectors.

An interleaved block interleaves two or move VOBs in order to realize seamless reproduction in two or more routes. An interleave arrangement is a structure in which each VOB is divided into the same number of interleaved units ILVUs. Among interleaved units of a certain VOB, an interleaved unit of another VOB is arranged. In one interleaved block, if “m×VOBs” is divided into “n×interleaved units”, each interleaved unit is arranged in the sequence shown in FIG. 10.

Herein, (i, j) denotes j-th interleave unit of i-th VOB.

Each VOB in the interleaved unit is read by repeating the process of reading the interleaved unit and jumping to the beginning of next interleaved unit in the same VOB. By properly setting the size of interleaved unit, the time required for jumping may be suppressed within an allowable range.

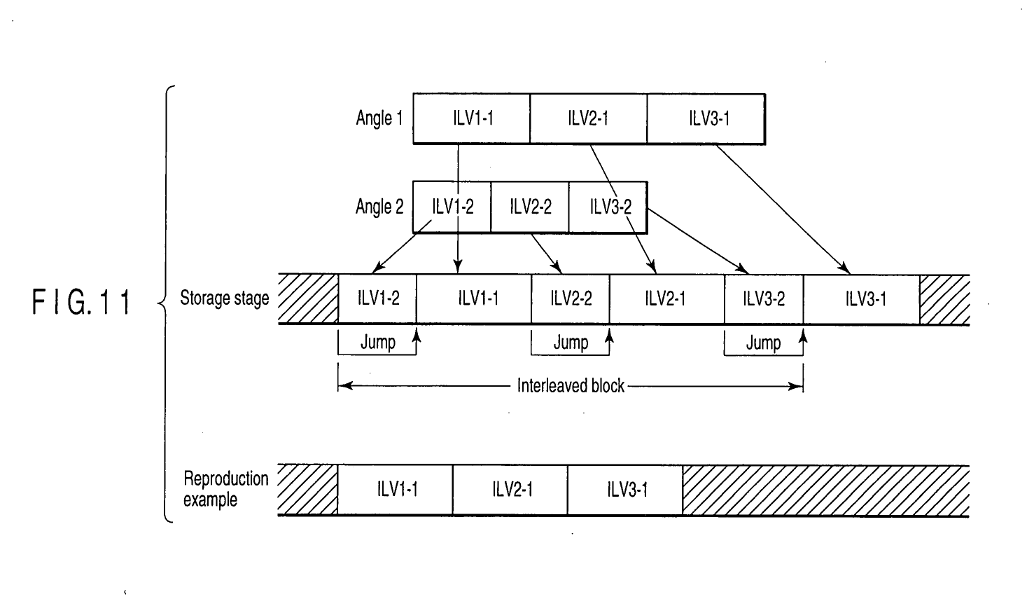

FIG. 11 shows two video objects VOBs, that is, video objects VOBs of scenes of angle 1 and angle 2 being divided into three interleaved units each ILVU1-1 to ILVU3-1, ILVU1-2 to ILVU3-2, and arranged and recorded on one track, showing, for example, reproduction output when reproducing angle 1. In this case, information of angle 2 is not taken in.

Example of Reproduction Route of Presentation Data

Data is reproduced without interruption along different routes of presentation data. Such data reproduction is called seamless play.

In a section in which seamless play of multiple routes is performed, the sequence of presentation data has an interleaved structure as shown in FIG. 11.

In the interleaved block, a presentation engine reproduces presentation data while reading the data continuously along a specified reproduction route and skipping unnecessary data.

While jumping, the presentation engine requires a track buffer in order to provide interruption of data supply to the decoder.

Continuous supply of data into the decoder while jumping is guaranteed by controlling the data quantity in the track buffer by making use of difference between Vr (data transfer rate from the disk to the track buffer) and Vo (consumption rate in the decoder), and arranging data sequence on the disk. Definition of Vr and Vo, and rule of disk sequence are determined separately.

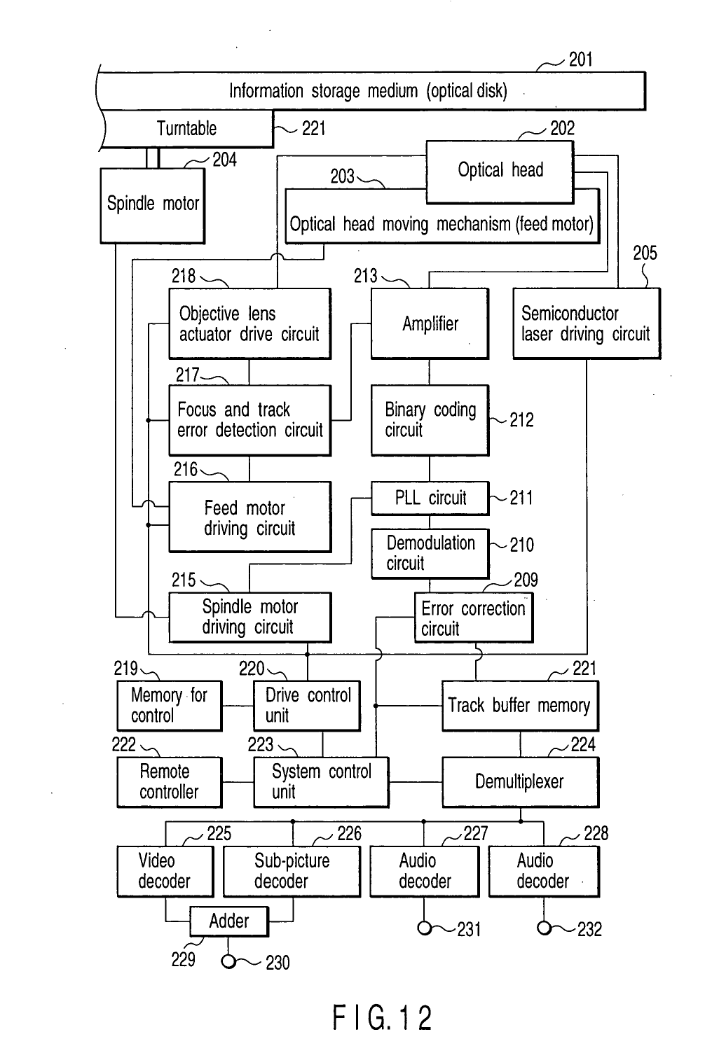

FIG. 12 shows an example of a configuration of an optical disk reproducing apparatus capable of reproducing the DVD-ROM disk described above. In this optical disk reproducing apparatus, already recorded information is reproduced by using a focusing spot from a specified position on an information storage medium (optical disk) 201. As means for achieving this basic function, the focusing spot is traced along the track (not shown) on the information storage medium 201. Although not shown in the drawing, an optical head 202 incorporates a photo detector for detecting the emission quantity of a semiconductor laser device. A semiconductor laser driving circuit 205 calculates the difference between the output of the photo detector (detection signal of the emission quantity of the semiconductor laser device) and a specific quantity of light necessary for reproduction, and feeds back the driving current, on the basis of the result, to the semiconductor laser device in the optical head 202.

The optical disk 201 is put on a turntable 221, and rotated and driven by a spindle motor 204. Supposing to be in reproduction mode at the present, the information recorded in the optical disk 201 is picked up by the optical head 202. The optical head 202 is movable in the disk radial direction by driving an optical head moving mechanism 203 by a feed motor driving circuit 216.

Basically, the optical head 202 is composed of a semiconductor laser device as a light source, a photo detector, and an objective lens although not shown in the drawing.

Laser light emitted from the semiconductor laser device is focused on the information storage medium (optical disk) 201 by the objective lens. The laser light reflected by the light reflection film of the information storage medium (optical disk) 201 is photoelectrically converted by the photo detector.

The detection current obtained by the photo detector is converted into a voltage by an amplifier 213, and a detection signal is obtained. This detection signal is processed in a focus and track error detection circuit 217 or a binary coding circuit 212. Generally, the photo detector is divided into plural light detecting regions, and light quantity changes in individual light detecting regions are detected individually. The individual detection signals are added or subtracted in the focus and track error detection circuit 217, and off-focus and off-track are detected. Changes in the quantity of reflected light from the light reflection film of the information storage medium (optical disk) 201 are detected, and the signal on the information storage medium 201 is reproduced.

The objective lens (not shown) for focusing the laser light emitted from the semiconductor laser device on the information storage medium 201 is mounted on an objective lens actuator (not shown). The objective lens is configured to be movable in two axial directions, that is, the vertical direction to the information storage medium 201 for correction of off-focus, and the radial direction of the information storage medium 201 for correction of off-track. Usually, it is moved in an electromagnetic driving system by a permanent magnet and coil.

For off-focus correction or off-track correction, there is an objective lens actuator driving circuit 218 which is a circuit for supplying a driving current to the objective lens actuator (not shown) in the optical head 202 depending on the output signal (detection signal) of the focus and track error detection circuit 217. To realize fast response of objective lens motion up to a high frequency region, a phase compensation circuit is incorporated for improving the characteristics conforming to the frequency characteristics of the objective lens actuator.

The objective lens actuator driving circuit 218, depending on the instruction from a control unit 220, executes on/off processing of focus/track error correction (focus/track loop), moves the objective lens at low speed in the vertical direction (focus direction) of the information storage medium 201, (executed while focus/track loop is off), and moves slightly in the radial direction (track crossing direction) of the information storage medium 201 by using kick pulse, and thereby moves the focusing spot to a nearby track.

Linear speed of the information storage medium 201 is detected by a reproduction signal obtained from the information storage medium 201. That is, the output detection signal (analog signal) from the amplifier 213 is converted into a digital signal by the binary coding circuit 212, and from this signal, a specific period signal (reference clock signal) is generated in a PLL circuit 211. The spindle motor driving circuit 215 determines the difference between the target linear speed given from the drive control unit 220 and a specific period signal (linear speed at the present), and applies a driving current depending on the result to the spindle motor 204, thereby controlling the rotation of the spindle motor 204.

When reading out information on a specific position on the information storage medium 201, usually, processing is done in two stages, that is, rough access process and precise access process.

In rough access process, first, the radial position of access destination is determined by calculation, and distance to the current position of the optical head 202 is found. Speed curve information for reaching the moving distance of the optical head 202 in the shortest time is preliminarily recorded in a semiconductor memory 219 for control. The control unit 220 reads this information, and controls to move the optical head 202 in the following method according to this speed curve. The control unit 220 issues a command to the objective lens actuator driving circuit 218 to turn off track loop, and controls the feed motor driving circuit 216 to start to move the optical head 202. When the focusing spot crosses the track on the information storage medium 201, a track error detection signal is generated in the focus and track error detection circuit 217. Using this track error detection signal, the relative speed of the focusing spot to the information storage medium 201 can be detected. The feed motor driving circuit 216 always calculates the difference between the relative speed of the focusing spot obtained from the focus and track error detection circuit 217 and the target speed information sequentially sent from the control unit 220, and moves the optical head 202 while feeding back the result to the driving current to the optical head driving mechanism (feed motor) 203. When the optical head 202 reaches the target position, the control unit 220 issues a command to the objective lens actuator driving circuit 218, and turns on the track loop.

In this rough access process, since the focusing spot reaches to a position slightly deviated from the target track due to detection error or the like, it is corrected by the subsequent precise access process. First, while tracing the focusing spot along the track on the information storage medium 201, the address of this area or track number is reproduced. The current position of the focusing spot is calculated from this address or track number, the number of error tracks from the desired target position is calculated in the control unit 220, and the number of tracks necessary for moving the focusing spot is noticed to the objective lens actuator driving circuit 218. In the objective lens actuator driving circuit 218, when a set of kick pulses is generated, the objective lens is slightly moved in the radial direction of the information storage medium 201, and the focusing spot moves to next track. In the objective lens actuator driving circuit 218, the track loop is temporarily turned off, kick pulses are generated by the number of times conforming to the information from the control unit 220, and the track loop is turned on again. After the precise access process, the control unit 220 reproduces information (address or track number) of the position traced by the focusing spot, and confirms a successful access to the target track. If still deviated, the precise access process is repeated until successfully reaching finally.

If the difference between the radial position of the access destination and the current radial position is slight, the access is corrected by the precise access process only.

As shown in FIG. 12, the track error detection signal output from the focus and track error detection circuit 217 is also input in the motor driving circuit 216. At “the time of access control” mentioned above, the motor driving circuit 216 is controlled by the control unit 220 so as not to use the track error detection signal. When it is confirmed that the focusing spot has reached the target track by access, the control unit 220 issues a command, and part of the track error detection signal is supplied as driving current to the optical head driving mechanism (feed motor) 203 by way of the motor driving circuit 216. This control is continued during continuous reproduction process. If reproduction or record/erase process is carried out continuously for a long time, the focusing spot position is gradually moved to the outer circumferential direction or inner circumferential direction. When part of the track error detection signal is supplied as driving current to the optical head moving mechanism (feed motor) 203, the optical head 202 is gradually moved to the outer circumferential direction or inner circumferential direction conforming to this signal. Thus, the track deviation correction range of the objective lens actuator can be suppressed to a small range.

By contrast to the signal to be recorded on the information storage medium 201, a demodulation circuit 210 and an error correction circuit 209 are provided for satisfying the requirements of correction of recorded information error due to defect on the information storage medium 201, simplification of a reproduction process circuit by nullifying the direct-current component in the reproduction signal, and recording of information at density as high as possible on the information storage medium 201. Detecting changes in the quantity of reflected light from the light reflection film of the information storage medium (optical disk) 201, the signal on the information storage medium 201 is detected, and amplified by the amplifier 213. This signal has an analog waveform. The binary coding circuit 212 converts this signal into binary digital signals of 1 and 0 by using a comparator.

From thus obtained reproduction signal, a reference signal for information reproduction is taken out in the PLL circuit 211. The PLL circuit 211 incorporates an oscillator of variable frequency. Frequency and phase are compared between the pulse signal (reference clock) output from the oscillator and the output signal of the binary coding circuit 212, and the result is fed back to the oscillator output. The demodulation circuit 210 has a conversion table showing the relation between the modulated signal and the demodulated signal. The signal is returned to the original signal by referring to this conversion table according to the reference clock obtained in the PLL circuit 211, and is sent to the error correction circuit 209.

The error correction circuit 209 has a semiconductor memory, and corrects errors when data is accumulated in the error processing unit, and then sends the data to a track buffer 221.

A demultiplexer 224 reads out data from the track buffer 221, and separates and produces video information, subtitle and text information, audio information, control information, etc. This is because subtitle and text information (sub-picture), audio information and the like are recorded corresponding to the video information in the disk 201. In this case, as the subtitle and text information and audio information, various languages can be selected, and they are selected according to the control of a system control unit 223. Operation input by the user is given to the system control unit 223 through a remote controller 222.

The video information separated by the demultiplexer 224 is put into a video decoder 225, and decoded according to the system of the display device. For example, the video is converted into NTSC, PAL, SECAM, wide screen or the like. The sub-picture separated by the demultiplexer 224 is put into a sub-picture decoder 226, and decoded into subtitle or text image. The video signal decoded by the video decoder 225 is put into an adder 229, and added to the subtitle and text image (sub-picture), and the addition output is sent to an output terminal 230. The audio information selected and separated by the demultiplexer 224 is put into an audio decoder 227 and demodulated, and sent into an output terminal 231. The audio processing unit comprises the audio decoder 227 and an audio decoder 228. Voice of other languages can be reproduced and output to an output terminal 232.

As mentioned above, usually, the data reading rate is almost constant while the video data is recorded in a variable rate system, and therefore, the demanded reading rate of the decoder 225 varies. When recorded in a multi-scene system, data is not recorded continuously on the disk, but is recorded intermittently, and hence the data reading is not continuous, but the decoder 225 demands data continuously. To absorb this difference, the reproduction data is once stored in the track buffer 221, and supplied into the demultiplexer 224 depending on the decoding rate. In ordinary continuous reproduction, when the data quantity in the track buffer 221 overflows, the system control unit 223 executes kick-back process. The kick-back process is a process of reading data again for the portion of specified sectors already being read out, and it is function for compensating for data missing even if data overflows in the track buffer 221.

When reproducing an optical disk containing multiple stories, a choice of multiple stories as management information of the disk is displayed as a menu on a monitor screen or in a sub display unit of the system. The user, while observing the menu, can preliminarily select a branch story through the remote controller 222. When the selection information is given, the system control unit 223 obtains identification information of the branch story, extracts the data having this identification information added to the header from the track buffer 221, and gives the data to the demultiplexer 224.

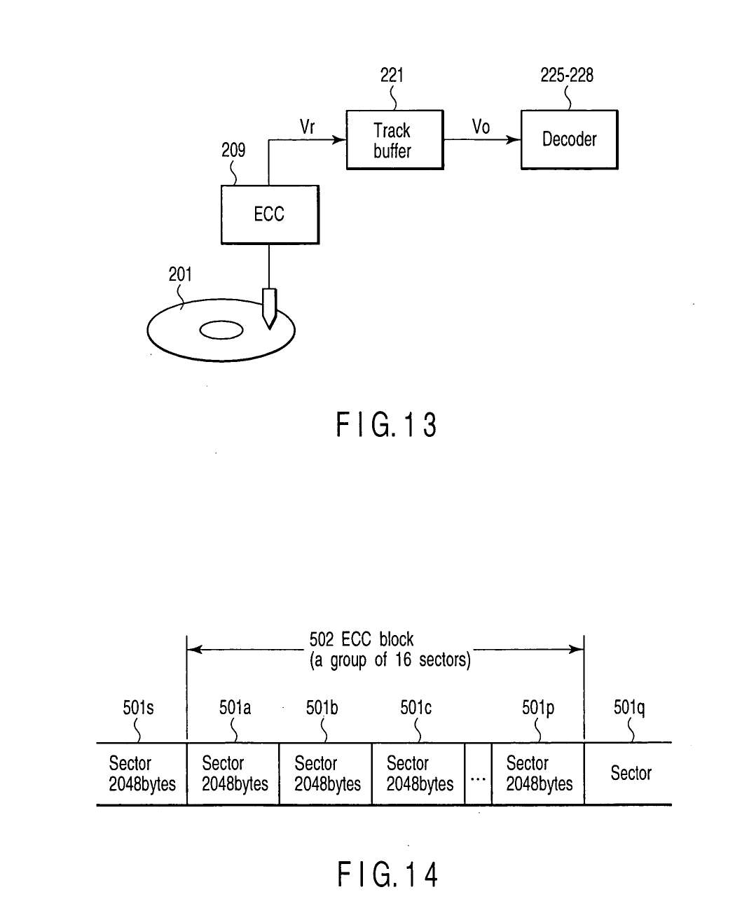

FIG. 13 is a simplified view of the reproducing apparatus shown in FIG. 12. In the case of jump reproduction mentioned above, it is required to supply data to the decoders 225, 226, 227 and 228 without interruption. For this purpose, the track buffer 221 is provided. Vr is a transfer rate of data to be supplied from the error correction processor 209 to the track buffer 221, and Vo is a transfer rate obtained by combining all data to be supplied from the track buffer 221 to the decoders 225, 256, 257 and 258. Data is read out from the disk in the error correction block unit. In the case of DVD-ROM, one error correction block corresponds to 16 sectors as shown in FIG. 14.

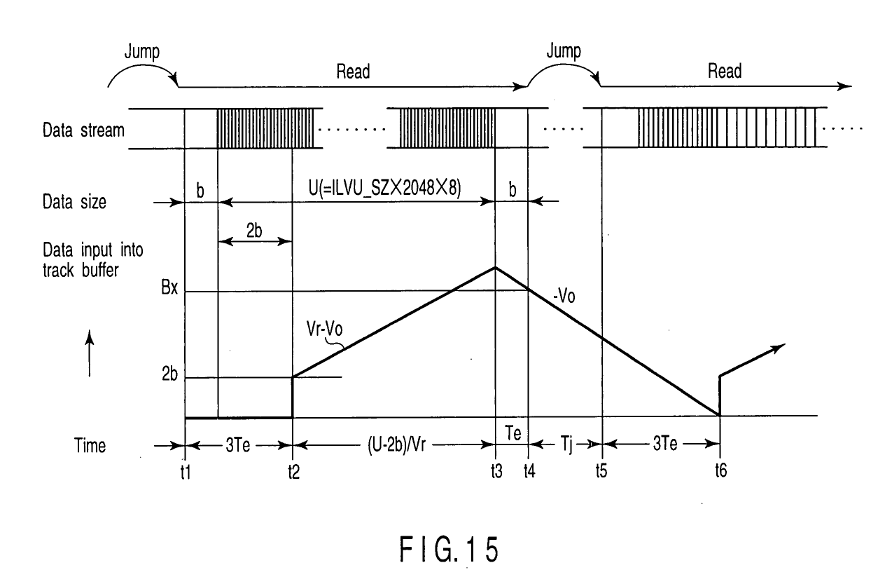

FIG. 15 shows increase and decrease of data input into the track buffer 221 when reproducing an interleaved block in the worst case. At this time, jump of the interleaved unit on the recording track, and reading and reproduction of interleaved data at jump destination are executed. In the worst case, reading of the interleaved unit is started in a state in which the track buffer is empty, and after reading, it is jumped to next interleaved unit. The beginning sector of the interleaved unit is the final sector of the ECC block, and the final sector of the interleaved unit is the beginning sector of the ECC block. That is, the remainder of two ECC blocks is not valid. Reading time Te of one ECC block is b/Vr. Herein, Vr is a transfer rate at reference speed, and b is a data size on one ECC block (for example, 262144 bits).

In FIG. 15, Vr is a transfer rate of data to be supplied from the error correction circuit 209 to the track buffer 221 (since error correction is executed in the unit of error correction block, practically, it may be an intermittent operation, and precisely, it is an average transfer rate including intermittent time), and Vo is a transfer rate obtained by combining all data to be supplied from the track buffer 221 to the decoders 225, 256, 257 and 258.

Tj is a jump time, which includes a track seeking time and a necessary accompanying time (latency time). Bx is the quantity of data remaining in the track buffer 221 when jump is started (time t4).

The curve in FIG. 15 showing the quantity of data shows accumulation of data in the track buffer 221 at an accumulation rate of gradient (Vr−Vo) from time t2. The curve also shows that the quantity of data in the track buffer 221 is zero at time t6. The data in the track buffer 221 decreases at a decrease rate of gradient −Vo from time t3, and becomes zero at time t6.

The following is obtained from this curve. The condition of continuous output of data from the track buffer 221, that is, the condition of continuous supply of data to the decoder 225 without interruption is as follows.
Bx≧Vo(Tj+3Te) (1)

The size ILVU_SZ (sectors) of the interleaved unit is as follows.
ILVU_{—}SZ≧{(Tj×Vr×10⁶+2b)/(2048×8)}×Vo/(Vr−Vo) (2)

Now, let's see how much capacity is needed for the track buffer 221. The capacity of the track buffer 221 is desired to be large enough not to interrupt output data of the track buffer 221 even if the reproducing apparatus kicks back and jumps to next interleaved unit successively. Kick-back is a state in which the pickup waits for reading while the disk makes one rotation, and it is to seek reading position to next track after the disk makes one rotation.

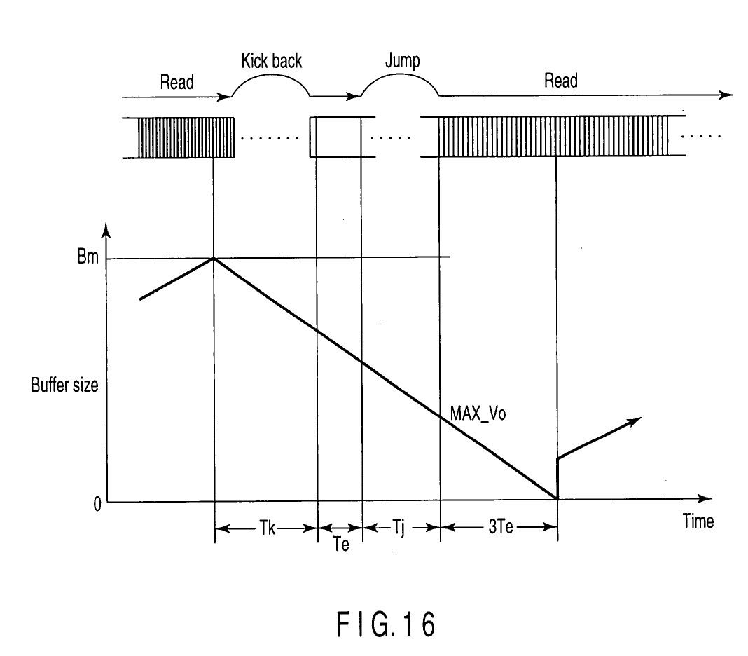

FIG. 16 shows the time of kick-back operation in the recording apparatus followed by jump operation of maximum class, and the decrease status of data in the track buffer 221. Supposing the size of the track buffer 221 to be Bm, the kick-back time (corresponding to one rotation of disk) to be Tk, reading time of one ECC block (24 msec, that is, 0.024 sec) to be Te, the jump time (track seek time tj+latency time Tk) to be Tj, and the maximum reading rate of the decoder in the interleaved block to be Voₘₐₓ, if the kick-back operation in the recording apparatus is immediately followed by the jump operation of maximum class, the capacity of the track buffer 221 for guaranteeing continuous data transfer from the track buffer is required as follows.
Bm≧{(2Tk+tj+4Te)×Voₘₐₓ×10⁶}/(2048×8) (3)

Hence, it is known that the required track buffer size depends on Tk, tj and Te of the reproducing apparatus, and tj depends on the performance of seek operation. Further, Tk and Te depend on the rotating speed of the disk.

As explained in relation to the prior art, recently, household displays applicable to high definition (HD) images are spreading, and the information storage medium is also coming in the trend of high definition (HD) images. In the conventional DVD-Video standard, a movie of standard definition (SD) and standard length can be recorded in one-layer DVD-ROM. However, owing to the recent progress in moving picture compression technology, high definition (HD) images of about four times of pixels can be compressed to about double data quantity in average, and hence a movie can be recorded in a two-layer DVD-ROM. That is, the data quantity is double in average, but is triple in part. Therefore, the data rate Vo supplied from the track buffer to the decoder is 3 times of the conventional rate, and the required data rate Vr being read out from the disk and supplied into the track buffer is also 3 times of the conventional rate. In the conventional DVD-Video standard, moreover, the maximum data rate Vomax in the multi-scene section (interleaved block) is set at a smaller value than in other sections. However, from the viewpoint of the picture quality, it is desired to increase the data rate Voₘₐₓ in the multi-scene section so as to be equal to that of other sections. When the maximum data rate Voₘₐₓ in the multi-scene section is increase to meet this demand, the size of the interleaved unit is larger, and the jumping distance must be longer.

Incidentally, in many optical disks including a DVD-ROM, since the linear recording density is constant, to read out information at a constant data rate Vr, it is required to vary the rotating speed by the radius. It can be realized by controlling the spindle motor 204, but when the torque of the spindle motor is constant, the time required for changing the rotating speed in the same radius is nearly proportional to the data rate Vr and jump distance. Actually, as general characteristics of a motor, as the rotating speed increases, the viscous resistance and wind loss increase, and therefore as the rotating speed becomes faster, the available torque usable for acceleration or deceleration of disk rotating speed is decreased.

In the conventional DVD-Video standard, the disk rotating speed could be followed up until end of jump (the required follow-up time being about tens of milliseconds). When demanded to increase the disk rotating speed three times and extend the jump distance, however, it is hard to increase the torque of the spindle motor 204, and even if the jump is over, it is hard to keep the linear speed, that is, the reading rate. In portable appliances, in particular, the available peak electric power is limited because of battery operation. To increase the peak electric power, the battery size must be increased, which leads to increase in size and weight of the apparatus, possibly spoiling the commercial value. It is hence not realistic to increase the motor torque.

When reproducing a two-layer disk, in the case of jumping from the outer circumference to the inner circumference, the disk rotating speed must be increased. If failing to follow up due to lack of torque, however, the data rate Vr is lower than the assumed reference value, the track buffer may be empty and the image may be interrupted. In particular, since the data quantity is large in high definition video, a two-layer disk is widely used, and this is a serious problem.

In some of the current DVD-ROM drives capable of reproducing at high speed, the CAV system for rotating at constant rotating speed the disk recorded at constant linear speed is employed instead of the CLV system for rotating at constant linear speed. In this case, since the reading data rate Vr is kept over 3 times, if the inner circumference is set at 3 times, the linear speed of the outermost circumference is about 7.3 times. If this system can be employed, the above problem can be solved.

However, the guaranteed reading rate even in, for example, a current DVD-ROM standard is an equal speed, and disk warp, eccentricity and other mechanical properties are determined by assuming an equal speed reproduction. If the disk is warped or eccentric, the objective lens actuator must generate a force to follow up, but since the acceleration caused by distortion or eccentricity is proportional to a square of linear speed, in the case of, for example, 8× variable-speed, a force of 64 times is required as compared with an equal speed. It is actually difficult to generate such a large force. Therefore, even in the case of the drive capable of reproducing at high speed, since high speed reproduction is difficult depending on mechanical properties such as warp of disk, the reproduction speed is lowered in such a case. That is, if the warp or eccentricity of the disk is sufficiently smaller as compared with the standard, high speed reproduction may be possible, but when large, it is impossible to follow up, and it is forced to lower the reproduction speed.

In a disk capable of recording high definition (HD) video, maximum values of disk warp and eccentricity must be determined in order to reproduce at 3× variable-speed. However, considering the current disk manufacturing technology, such as aging effects, cost, and performance and cost of optical disk recording apparatus, it is not realistic to determine the standard allowing reproduction in the CAV system of 3× variable-speed at the innermost circumference, and the problem cannot be solved by reproducing in the CAV system.

This embodiment is devised to solve these problems, and provides an optical disk device capable of keeping the data reading rate above a certain level.

In the embodiment, in order to reproduce a high definition video requiring a high data reproduction speed, the disk 201 must be rotated at a linear speed of about 3 times of the conventional speed. In such fast rotation, the conventional brush motor is limited in the brush life, and it is preferred to use a brushless motor as the spindle motor 204. A brushless motor generally has a Hall element in order to generate timing for changing over the direction of the current flowing in the motor coil, and can produce pulses at frequency proportional to this rotating speed of the motor by using it, so that the rotating speed can be detected by the pulse signal.

Suppose the disk 201 has a portion of time series data such as movie being interleaved in order to realize multiple scenes, that is, being recorded intermittently as seen from a specific scene. In the data arrangement on the disk, supposing to be reproduced by a certain reproducing apparatus of which data reading rate is Vr, and maximum jump time is Tjₘₐₓ when jumping in the maximum jump sector distance Sₘₐₓ (that is, maximum intermittent distance), the data arrangement is determined and recorded such that the interleaved location can be reproduced seamlessly without interruption. When the denominator and numerator of the right side of formula (2) are divided by Vr, Vr is eliminated from the numerator, and the denominator becomes 1−(Vo/Vr). Therefore, when Vr increases, the denominator becomes larger, and it is known that the minimum required size of the interleaved unit becomes smaller. In the optical disk device for reproducing this disk, hence, supposing the data reading rate Vr to be lower limit reading rate Vrₘᵢₙ, if the data reading rate can be kept above Vrₘᵢₙ, seamless reproduction is guaranteed even if the data reading rate varies. Also as known from the above formulas (2) and (3), the jump time Tj may be smaller than the value assumed when recording in the disk when reproducing at the optical disk device side. Incidentally, in a system of saving the data remaining from the difference with the data rate used in the decoder, and decoding the data saved in the buffer when data cannot be read from the disk in the case of jumping, the same should hold true even in the system different from formulas (2) and (3).

Jump occurs in any place, but the embodiments permit jumps only in an increasing direction of logical sector number. Therefore, in the case of the two-layer disk, interlayer jump from layer 0 to layer 1 may occur in the midst of seamless reproduction. In the two-layer disk, supposing the logical sector numbers are set in the system shown in FIG. 4C, it is an exception when logical sector numbers are set in the method of FIG. 4B. That is, reading starts from the inner circumference to the outer circumference in layer 0, and from the outer circumference in layer 1. Therefore, when moving from the end of layer 0 to the start of layer 1, the optical head 202 is not moved in the radial direction except for the radial error of the track of the disk.

Incidentally, in the case of multi-angle reproduction, since seamless changeover from a certain angle to another angle is demanded, in FIG. 10, a maximum jump possible to occur, for example, from cell of (1, 1) is not jump to cell of (1, 2), but is jump to (m, 2).

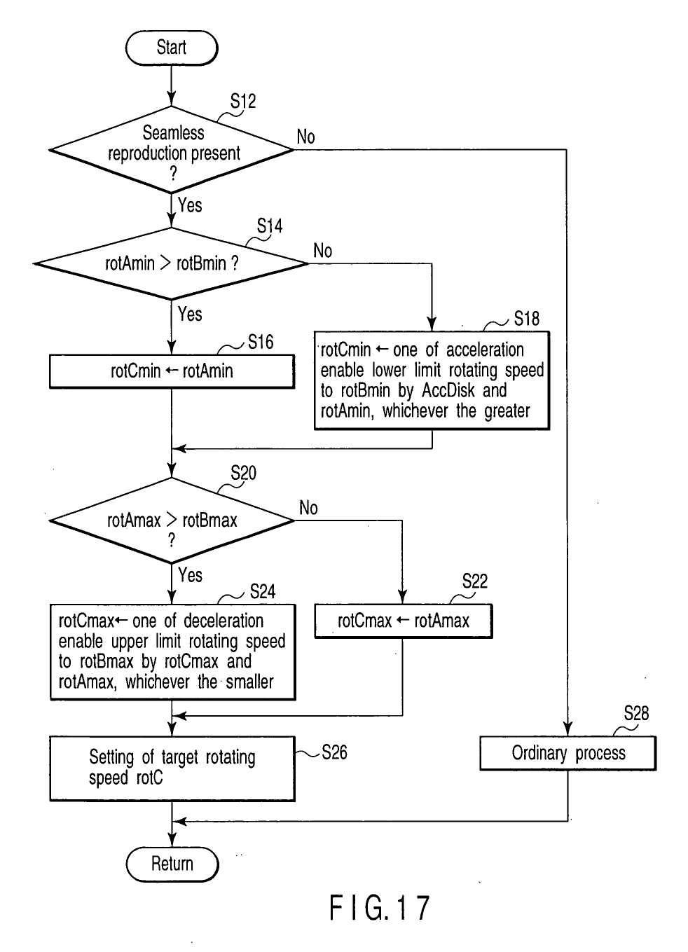

Referring to a flowchart in FIG. 17, a subroutine for controlling the rotating speed of the spindle motor 204 will be explained.

This subroutine relates to the operation of the system control unit 223 and drive control unit 220 of the optical disk device, which is executed when a disk is inserted, when instructed from the host side, or while reading the disk. In step S12, it is determined whether or not the disk 201 is a movie or the like demanding seamless reproduction. In the case of the disk demanding seamless reproduction, in step S14, it is attempted to compare the disk rotating speed rotAₘᵢₙ [rpm] necessary for obtaining the lower limit reading rate Vrₘᵢₙ [Mbps] (that is, lower limit reading linear speed LinAₘᵢₙ) of data necessary for seamless reproduction at the current reading position, and the disk rotating speed rotBₘᵢₙ [rpm] necessary for obtaining the lower limit reading rate Vrₘᵢₙ [Mbps] of data necessary for seamless reproduction after occurrence of jump of the maximum jump distance Sₘₐₓ.

When the rotating speed rotBₘᵢₙ is greater, in step S18, the lower limit rotating speed capable of accelerating at acceleration degree AccDisk [rpm/s²] up to the lower limit disk rotating speed rotBₘᵢₙ for obtaining the data reading rate Vrₘᵢₙ Of the disk 201 during the jumping time Tjₘₐₓ [s], or the rotating speed rotAₘᵢₙ, whichever the greater, is set as the current lower limit disk rotating speed rotCₘᵢₙ [rpm]. To the contrary, when the rotating speed rotBₘᵢₙ is smaller, in step S16, the rotating speed rotAₘᵢₙ is set as the lower limit disk rotating speed rotCₘᵢₙ.

In step S20, the rotating speed rotAₘₐₓ at the current position of the specified upper limit reading rate LinBₘₐₓ [Mbps] is compared with the rotating speed rotBₘₐₓ at the upper limit reading rate LinBₘₐₓ at the position after occurrence of jump of the maximum jump distance Sₘₐₓ. When the rotating speed rotAₘₐₓ is greater, in step S24, the upper limit rotating speed capable of decelerating at acceleration degree AccDisk [rpm/s²] up to the upper limit disk rotating speed rotBₘₐₓ during the jumping time Tjₘₐₓ [s], or the rotating speed rotAmax, whichever the smaller, is set as the current upper limit disk rotating speed rotCₘₐₓ [rpm]. To the contrary, when the rotating speed rotBₘₐₓ is greater, in step S22, the rotating speed rotAₘₐₓ is set as the current upper limit disk rotating speed rotCₘₐₓ [rpm].

The spindle motor 204 is controlled by determining the target rotating speed rotC such that the rotating speed (disk rotating speed) of the spindle motor 204 at the current position is greater than the lower limit disk rotating speed rotCₘᵢₙ and lower than the upper disk rotating speed rotCₘₐₓ.

When seamless reproduction is not necessary, in step S28, ordinary rotating speed process is executed.

In the above explanation, for the sake of simplicity, the maximum distance jump destination is a place apart by Sₘₐₓ, but actually there may be no place apart by Sₘₐₓ, or a layer may be different from the currently reproduced layer. For example, when jumping from the outer circumference to the inner circumference while reproducing layer 1, if there is no place apart by Sₘₐₓ, the value of Sₘₐₓ is reduced to a position at which data exists. Or when layers are changed by jumping, the current rotating speed is compared with the rotating speed at a place apart by Sₘₐₓ, and also compared with the rotating speed in the outermost circumference. The maximum of the individual obtained results of Cₘᵢₙ is set as the final Cₘᵢₙ, and the minimum of the individual values of Cₘₐₓ is set as the final Cₘₐₓ.

Generally, the relation between the rotating speed [rpm] and the reading linear speed at radius R is as follows:
Rotating speed=(linear speed/2πR)×60
where 60 is a coefficient for converting the rotating speed per second into the rotating speed per minute.

Supposing the radius at which sector to be read exists to be R [m] and the lower limit reading linear speed to be LinAₘᵢₙ, LinBₘᵢₙ [m/s], the lower limit disk rotating speeds rotAₘᵢₙ, rotBₘᵢₙ [rpm] are expressed as follows.
rotAₘᵢₙ=(LinAₘᵢₙ/2πR)×60
rotBₘᵢₙ(LinBₘᵢₙ/2πR)×60

Generally, the relation between the linear speed [m/s] and the data reading rate [Mpbs] is as follows.
Data reading rate=(linear recording density/10⁶)×linear speed

The linear recording density is a constant determined by the disk. Therefore, the linear speed and reading rate can be easily converted.

Supposing, for example,
Rₘᵢₙ: radius [m] of the innermost circumference of the data area (fixed value in the DVD-ROM standard);
Sₘᵢₙ: minimum value of the physical sector number of the data area (fixed value in the DVD-ROM standard, and recorded in the region indicated by data area allocation 827 in FIG. 3 on the disk);
Tp: track pitch [microns] of the disk (fixed value in the DVD-ROM standard, and recorded in the region indicated by recording density 826 in FIG. 3 on the disk);
Vref: specified linear speed [m/s] specified in the disk standard; and
User bit rate: bit rate [Mbps] of user data specified in the disk standard by rotating at specified linear speed Vref, the radius R [m] at which a physical sector number Nsec exists is calculated as follows:
   R=√({(Nsec−Sₘᵢₙ)×2048×8×Vref/(User Bit Rate×10⁶)}×Tp×10⁻⁶/π+Rₘᵢₙ²)
where 2048 is the number of bytes per sector, and 8 is the number of bits per byte. If the value of Nsec is negative, that is, in the case of layer corresponding to layer 1, an absolute value is given to Nsec in the above formula, and Sₘᵢₙ in layer 0 is given to Sₘᵢₙ.

Since the physical sector number and logical sector number correspond to each other by 1:1 as described in the disk structure, the jumping distance in the logical sector number and the jumping distance in the physical sector number are equal to each other. Therefore, the physical sector number at the maximum jump destination can be calculated from the current physical address and maximum jump sector distance.

After disk reproduction operation, the radial position CR of the physical sector number CNsec being currently read out can be calculated from the channel bit rate (calculated from the output of the PLL circuit 211) CCBR which is a bit rate before demodulation at this point, the shortest bit rate MPL, and the rotating speed CMr obtained from the Hall element (not shown) provided in the spindle motor 204. That is,
CR=CCBR×MPL/(2×π×CMr)

On the basis of this value, the Rₘᵢₙ may be replaced by CR and the Sₘᵢₙ may be replaced by CNsec. As a result, effects of disk manufacturing errors (due to errors in Tp and Rₘᵢₙ) can be decreased.

In this explanation, the generated angular acceleration given to the disk 201 is not taken into consideration, and when it is taken into consideration, the rotating speed rotC is as follows.

Assuming the magnitude of the generated angular acceleration given to the disk 201 to be AccDisk [rpm/s²], the lower limit rotating speed rotCₘᵢₙ is

$$\begin{matrix}{rotC}_{min} = {rotA}_{min} ( in the case of {rotA}_{min} > {rotB}_{min} as in \\ step S16 ) \\ = {rotB}_{min} - AccDisk \times {Tj}_{max} ( in the case of {rotB}_{min} - \\ AccDisk \times {Tj}_{max} \geq {rotA}_{min} as in step S18 ) \\ = {rotA}_{min} ( in the case of {rotB}_{min} - AccDisk \times \\ {Tj}_{max} < {rotA}_{min} as in step S18 )\end{matrix}$$

Since neither AccDisk nor Tjₘₐₓ is negative value, when the condition “rotBₘᵢₙ<rotAₘᵢₙ” is established, always the relation of rotBₘᵢₙ−AccDisk×Tjₘₐₓ<rotAₘᵢₙ is established. Therefore, the lower limit rotating speed rotCₘᵢₙ is expressed as:

$$\begin{matrix}{rotC}_{min} = {rotB}_{min} - AccDisk \times {Tj}_{max} ( in the case of \\ {rotB}_{min} - AccDisk \times {Tj}_{max} \geq {rotA}_{min} ) \\ = {rotA}_{min} ( in the case of {rotB}_{min} - \\ AccDisk \times {Tj}_{max} \geq {rotA}_{min} ) ,\end{matrix}$$

and hence it may be calculated in this procedure.

The upper limit rotating speed rotCₘₐₓ is, to the contrary, the limit rotating speed not exceeding the specified reading rate LinBₘₐₓ even if jumping a predetermined interval or less.

When the rotating speed rotCₘᵢₙ is always the same rotating speed rotAₘᵢₙ at any radius, it means the rotating speed change of the spindle motor is completed within a jump, and like a conventional DVD-Video, it can be reproduced at a constant linear speed LinAₘᵢₙ. Therefore, the target speed setting method of the embodiment has a greater effect than in the prior art when the rotating speed change of the spindle motor is not completed within a jump.

On the other hand, supposing the generated angular acceleration given to the disk 201 to be AccDisk [rpm/s²], the upper limit rotating speed rotCₘₐₓ is

$$\begin{matrix}{rotC}_{max} = {rotA}_{max} ( in the case of {rotA}_{max} \leq \\ {rotB}_{max} as in step S22 ) \\ = {rotB}_{max} + AccDisk \times {Tj}_{max} ( in the case of {rotB}_{max} + \\ AccDisk \times {Tj}_{max} \leq {rotA}_{max} as in step S24 ) \\ = {rotA}_{max} ( in the case of {rotB}_{max} + AccDisk \times \\ {Tj}_{max} > {rotA}_{max} as in step S24 )\end{matrix} \\ It can be similarly expressed as \text{:}$$

$$\begin{matrix}{rotC}_{max} = {rotB}_{max} + AccDisk \times {Tj}_{max} ( in the case of {rotB}_{max} + \\ AccDisk \times {Tj}_{max} \leq {rotA}_{max} ) \\ = {rotA}_{max} ( in the case of {rotB}_{max} + AccDisk \times \\ {Tj}_{max} > {rotA}_{max} )\end{matrix}$$

The upper limit reading liner speed LinBₘₐₓ is preferred to be the speed specified in the disk standard. However, in the case of an apparatus having a specification higher than the drive specification assumed in the disk standard, and if possible to reproduce at a speed exceeding the disk standard, the upper limit reading liner speed LinBₘₐₓ may be determined on the basis of such specification. As the case may be, the upper limit rotating speed may be limited, and different values may be set depending on the radius, such as constant rotating speed at the inner side of a certain radius and a constant linear speed at the outer side.

This explanation shows a basic principle, and for general explanation, RotAₘᵢₙ and RotBₘᵢₙ are compared, and RotAₘₐₓ and RotBₘₐₓ are compared, but other methods of evaluation may be also employed. For example, when sector numbers are ascending from the inner circumference to the outer circumference, supposing the sector number of the current position to be NsecA and the sector number after jump to be NsecB, in the case of NsecA<NsecB, the relation of RotAₘᵢₙ>RotBₘᵢₙ, and RotAₘₐₓ>RotBₘₐₓ is established. Therefore, the sector numbers may be compared instead of the rotating speed. Or, supposing the radius before jump to be RA and radius after jump to be RB, in the case of RA<RB, the relation of RotAₘᵢₙ>RotBₘᵢₙ, and RotAₘₐₓ>RotBₘₐₓ is established. Therefore, the radii may be compared instead of the rotating speed. In comparison of RotAₘₐₓ and RotBₘₐₓ, another method is established when the upper limit reading linear speed LinBₘₐₓ is equal before and after jump.

As mentioned above, when jumping after setting the current target rotating speed, the disk rotating speed right after jump is different from the value of the target rotating speed C at this radius. In the case of next jump, the disk rotating speed must be changed to C. That is, the rotating speed must be returned to C within reading time of one interleaved unit. The reading time of one interleaved unit may not be the actual time for reading at not lower than the lower limit reading rate LimAₘᵢₙ, but may be the time of reading at lower limit reading rate LimAₘᵢₙ assumed when creating data.

Suppose, in the case of high definition (HD) image, that the minimum value ILVU_SZ of the size of the interleaved unit can be determined same as in the conventional image. The minimum value of reading time of one interleaved unit is calculated from the reading rate Vr by determining the minimum value ILVU_SZ of the size of the interleaved unit in formula (2). Supposing Vr and Vo to be 3 times of the DVD-Video standard, that is, 33.24 Mbps and 30.24 Mbps, the reading time of the interleaved unit of the minimum size is 2.1 sec when Tj is 0.2 sec, and 5.2 sec when Tj is 0.5 sec. It is enough when the rotating speed may change in a long time of about 10 times of jump time Tj, and the load on the spindle motor is significantly lowered.

In this calculation, however, the jump time Tj is the maximum jump time possible to occur after the current interleaved unit. Therefore, if the rotating speed change of the disk motor takes as much as 10 times of jump time, supposing the jump time before reaching the current interleaved unit to be Tⱼ₋₁, in the case of Tj<Tⱼ₋₁, next jump occurs before reaching the target rotating speed C. In this case, since the jump distance is also short, the rotating speed change is small, and no problem occurs. That is, the size of the interleaved unit is also a necessary size for absorbing fluctuations of rotating speed change of the spindle motor occurring for subsequent jump. Therefore, if the actual jump distance is known when reading the interleaved unit immediately before this jump, usually, the disk is rotated at a rotating speed capable of assuring the lower limit reading rate LimAₘᵢₙ, and the spindle motor rotating speed can be raised as required before jump. In this method, however, the next jump destination must be determined before the time necessary for changing the rotating speed of the spindle motor. In the case of seamless changing to another scene during reproduction of multiple scenes, it takes longer than the time necessary for changing the rotating speed of the spindle motor, and the response is lowered than in the method of the embodiment, which is not preferable.

Thus, since the acceleration or deceleration time of the spindle motor is much longer than the jump time, the following effects are brought about. Supposing the angular acceleration of the spindle motor to be constant, the change of the rotating speed is proportional to the acceleration time. Since the angular acceleration is proportional to the motor torque, and the motor torque to the current flowing in the motor coil, the required current for the motor can be substantially saved, so that the power source can be reduced in size and the apparatus is also reduced in size. In particular, this merit is very large for a portable reproducing apparatus from the viewpoint of weight and size.

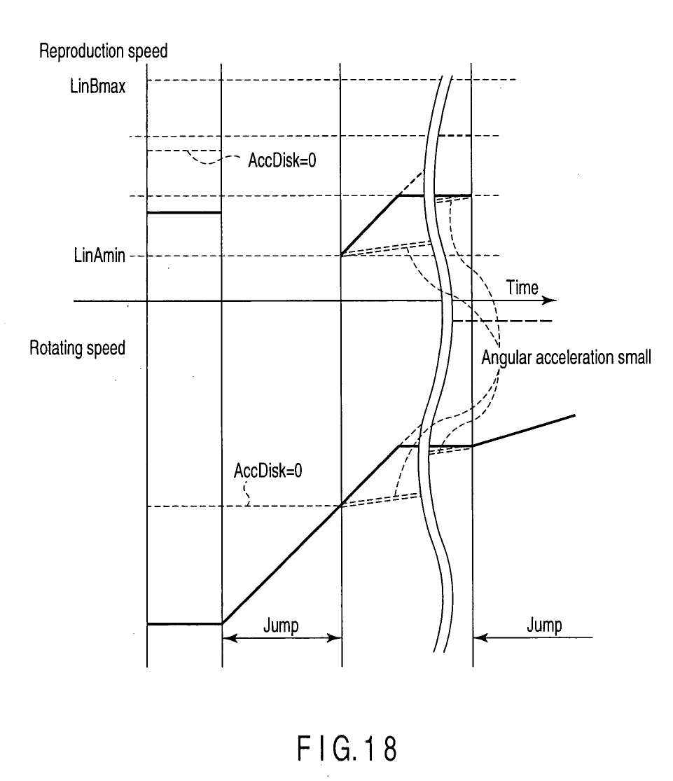

FIG. 18 is a schematic diagram showing three types of change of the disk reading rate (proportional to disk linear speed) and spindle motor rotating speed in the case of jumping during reproduction in the optical disk of the embodiment. In the diagram, a horizontal line shows that the linear speed or rotating speed is attracted to the target value of control. The diagram shows a case of maximum distance Sₘₐₓ jump in the inner circumferential direction during reproduction at the linear speed LinCₘᵢₙ (that is, rotating speed rotCₘᵢₙ, hereinafter Cₘᵢₙ is used if not particularly distinguishing linear speed and rotating speed, and similarly Cₘₐₓ is used). In a first example, the rotating speed of the spindle motor changes during jump, which is shown by a thick line. When moving from the outer circumference to the inner circumference, the value of LinCₘᵢₙ is not constant in linear speed, and is larger at the inner circumference, so that LinCₘᵢₙ after jump is larger than that before jump. Simultaneously with start of jump, acceleration of the spindle motor starts, and at the end of jump, reproduction starts at the lower limit reading rate LinAₘᵢₙ (that is, lower limit reading rate Vrₘᵢₙ). The speed has reached the target speed Cₘᵢₙ before next jump occurs.

A broken line shows a second example, in which the spindle motor is not accelerated during jump, that is, AccDisk=0, and acceleration of the spindle motor starts after end of jump. In this case, the value of Cₘᵢₙ is larger than in the case of thick line. During jump, the spindle motor keeps the same rotating speed, and at the end of jump, reproduction is started at the lower limit reading rate LinAₘᵢₙ. Thereafter, the rotating speed of the spindle motor changes depending on the angular acceleration. In this case, the spindle motor is accelerated at the same angular acceleration as in the previous example of thick line, and by operating indicated by thick line and dotted line, the target speed Cₘᵢₙ is reached sufficiently before occurrence of next jump.

A third example is similar to the second example, AccDisk=0, and the start is as indicated by dotted line, but the acceleration after jump is small, and operating according to double dot line. In this case, the target speed Cₘᵢₙ is reached immediately before occurrence of next jump.

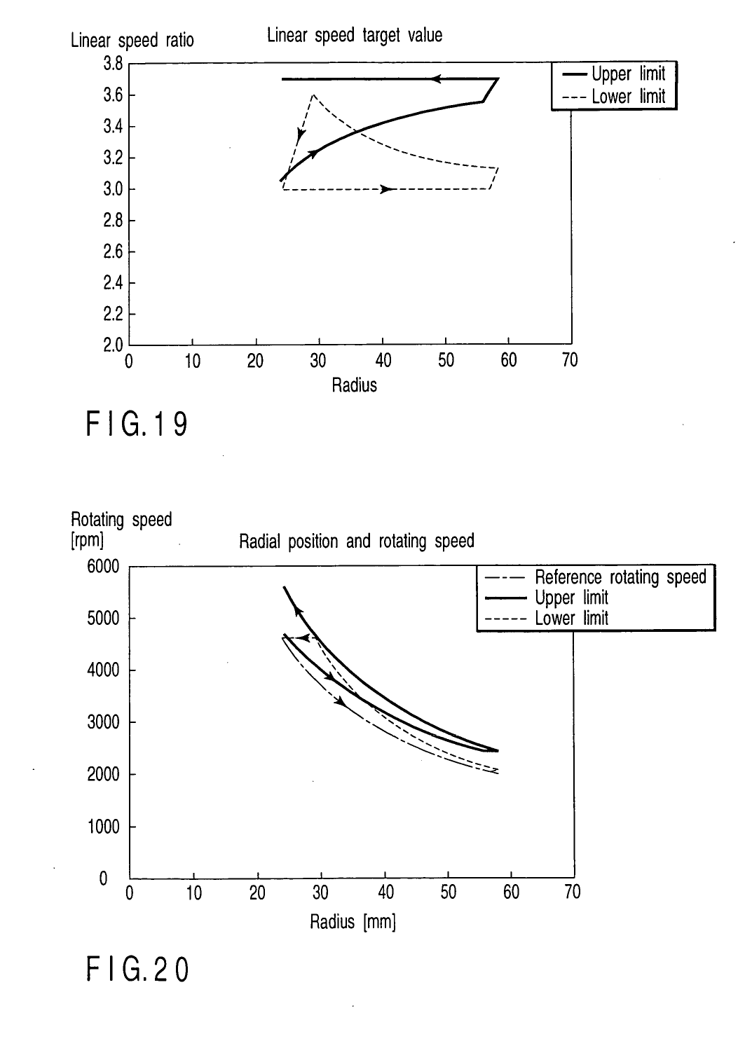

FIGS. 19 and 20 show calculation examples of upper limit and lower limit of control target of the rotating speed of the spindle motor in the optical disk device of the present embodiment. In these examples, assuming that the innermost circumference is 23.6 mm, the outermost circumference is 58 mm, the disk standard reading rate is 3× variable-speed, and the upper limit reading rate is 3.7× variable-speed, the speed is calculated at AccDisk of 0, that is, lower limit and Sₘₐₓ of 200,000. The axis of abscissas denotes the radial position in both diagrams, the axis of ordinates in FIG. 19 shows the linear speed at a ratio corresponding to the standard linear speed of a two-layer DVD-ROM disk, and the axis of ordinates in FIG. 20 shows the rotating speed. A direction arrow is given to each line to distinguish reproduction of layer 0, that is, when reading forward from the inner circumference to the outer circumference, and reproduction of layer 1, that is, when reading forward from the outer circumference to the inner circumference. The line of the reference rotating speed in FIG. 20 denotes the value in the CLV system of 3× variable-speed.

In the condition in FIG. 20, since the value of AccDisk is 0, it is not necessary to change the rotating speed of the spindle motor during jump. That is, operations as in second and third examples in FIG. 18 are enabled. Generally, during jump, a large electric power is needed in both the feed motor driving circuit 216 and the spindle motor driving circuit 215. The required electric power is increased in the case of a faster jump. In a portable appliance, in particular, sufficient electric power is not supplied and this is a serious problem. In this method, however, since it is enough to change the rotating speed of the spindle motor after jump, the peak of power consumption can be suppressed without delaying the jump time. In the second and third examples in FIG. 18, the spindle motor is accelerated after end of jump, but acceleration of the spindle motor may be started after end of operation of the feed motor which occupies a larger portion of power consumption during jump, that is, at the end of rough access process. When jumping toward the outer circumference, the motor is decelerated, and the same operation as in acceleration is possible. In the case of deceleration, on the other hand, by making use of viscous resistance of the spindle motor, it can be decelerated slightly without consuming electric power. Therefore, such slight deceleration can be done also at the time of rough access process without increasing the power consumption.

In this embodiment, the upper limit reading rate is 3.7× variable-speed. In the case of operation at the lower limit rotating speed, as known from FIG. 20, when reading in a direction from the outer circumference to the inner circumference, that is, when reading layer 1, in the vicinity of the innermost circumference of the highest rotating speed, the rotating speed is equal to the rotating speed RotCₘᵢₙ which is the lower limit reading rate LinCₘᵢₙ at the innermost circumference. In other words, according to the embodiment, the optical disk is used in the CAV system near the innermost circumference. Therefore, by rotating the spindle motor at the lower limit speed Cₘᵢₙ, it is not required to increase the maximum rotating speed of the spindle motor, and hence it is not needed to raise the performance of the spindle motor.

In the optical disk device of the embodiment, between the upper limit and the lower limit shown in FIGS. 19 and 20, the target speed C of the spindle motor at the current radial position is set. By setting closer to the lower limit as much as possible in consideration of errors and allowance, the noise of the optical disk device can be decreased. In layer 0, since jump is executed toward the outer circumference lower in rotating speed, the lower limit rotating speed is the rotating speed capable of obtaining the lower limit reading rate LimAₘᵢₙ. As going toward the outer circumference, a peripheral length is longer, and even in jumping of the same sector distance, the jump radius is shorter. Accordingly, since increase of linear speed after jump can be suppressed, the upper limit linear speed increases as going toward the outer circumference. As coming closer to the outer circumference, jumping of Sₘₐₓ (predetermined distance A) reaches layer 1, and the inclination changes significantly in both lower limit speed curve and upper limit speed curve. When moving to layer 1, this time, the jumping direction is toward the inner circumference declining in the linear speed, so that as coming closer to the inner circumference, the lower limit speed increases, and the upper limit speed becomes the upper limit reading rate LinBₘₐₓ. Close at the innermost circumference, since Sₘₐₓ exceeds the remaining sectors, the actually possible maximum jump destination is the innermost circumference, and this time the lower limit speed declines. As clear from the diagram, in this embodiment, when reproducing layer 0 and layer 1, a radius not capable of setting the common target speed C is present at the inner circumferential side, and the speed C of layer 1 going from the outer circumference to the inner circumference is faster than the speed C of layer 0.

Supposing the target speed C to be lower limit speed Cₘᵢₙ, in layer 1, in particular, a characteristically excellent target speed C is given in this embodiment. The curve of Cₘᵢₙ going from the outermost circumference to the inner circumference is higher in the rotating speed at the inner circumference, and the linear speed is also higher. As general properties of the disk itself, the outer circumference is greater in the displacement in the outward direction of the disk plane. Accordingly, when the linear speed is lower at the outer circumference, an excessive value is not required in the following capacity in the focus direction of the optical head. In the inner circumferential region, the rotating speed is constant and same as the rotating speed of the innermost circumference of layer 0. Since the eccentric acceleration of the optical disk generally does not depend on the radius, but depends on the rotating speed, and the rotating speed is not raised, it is not required to increase the following capacity in the track direction by the application of the embodiment. Besides, since the noise of the optical disk device owes much to the disk rotating direction, the noise level is also suppressed.

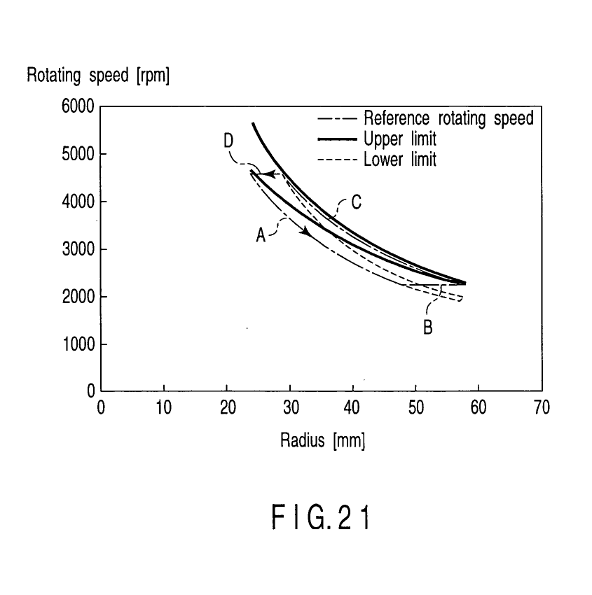

As a method of setting the target speed C, simplified curves as shown in FIG. 21 can be also used as shown in the region of FIG. 19. That is, four curves are set: the inner circumference of layer 0 is curve A of constant linear speed of 3× variable-speed, the inner circumference of layer 1 is curve D of constant rotating speed of Cₘᵢₙ, the outer circumference of layer 1 is curve C of constant linear speed of maximum linear speed ratio of Cₘᵢₙ in layer 1, and the outer circumference of layer 0 is curve B of constant rotating speed of rotating speed at the outermost circumference of curve C. Thus, the speed target for changing over the conventional linear speed constant control, and rotating speed constant control by the radius can be set and the control system can be simplified. Thus, the simplified curves can be also set in the target speed.

In such an optical disk device, when jumping on the basis of the information given from the operation unit 222, there are at least two types of jump. One is non-seamless jump when desired to reproduce a movie from an intermediate part, or desired to skip part or go back, and the other is seamless jump required when reproducing multiple scenes.

First, reproduction is started by non-seamless jump. In this case, when the disk speed, that is, the spindle motor rotating speed (rotating speed) or disk linear speed reaches the target speed C, data acquisition from the track buffer 221 is started, and the demultiplexer 224 is obtained, so that decoding in the decoders 225, 226, 227, 228 and output from the output terminals 230, 231, 232 are started.

Afterwards, in the case of seamless jump, regardless of the disk speed, data acquisition from the track buffer 221 continues. In the case of a DVD-ROM drive or similar device designed to decode by a host computer to which the optical disk device is connected, in non-seamless jump, when the disk speed reaches the target speed C, the data is sent out to the host computer through the drive interface. The non-seamless jump is provided for avoiding undesired phenomena, such as start decoding when the speed is low before elevation to the target speed, failing to maintain the data rate demanded by the decoder, and start of decoding before decreasing to the target speed, to the contrary, immediately followed by seamless jump to exceed the upper limit reading rate LinBₘᵢₙ, thereby causing reading error and failing to maintain the data rate.

As known from the explanation of the method of calculating the lower limit Cₘᵢₙ and upper limit Cₘₐₓ of the target speed C, Sₘₐₓ is an important value. From the viewpoint of power consumption and noise, the spindle motor should be rotated at low speed as far as possible. It is important to determine the upper limit of value of Sₘₐₓ by the standard, but in an actual disk, there may be no multiscene (multiplex portion), that is, Sₘₐₓ is 0, or the maximum jump distance (intermittent interval) may be shorter than the upper limit of the standard. Also in such a case, it is useless to rotate the spindle motor by determining the target speed C on the assumption of Sₘₐₓ as the upper limit of the standard. Instead, by manufacturing an optical disk describing Sₘₐₓ of information included in the disk in the physical format information in control data 814 in FIG. 2, for example, of the optical disk 201, in the optical disk device, the Sₘₐₓ information is read from the optical disk, and the target speed C is set. Alternatively, as attribute information of time series data recorded in the optical disk, for example, Sₘₐₓ information of individual video title sets VTS may be recorded in the video manager VMG. In the optical disk reproducing apparatus of the embodiment, by reading these values from the optical disk, an optimum target speed C can be set depending on the attribute information even in the same optical disk 201, and noise and power consumption can be decreased.

In the optical disk drive device having no decoder, the host computer at the connection destination acquires the value of Sₘₐₓ from the attribute information of the time series data, and gives the information to the optical disk drive device through the interface, so that the same operation as mentioned above can be realized.

As described herein, according to the first embodiment, since the acceleration speed of the spindle motor can be decreased, the current required for the motor can be substantially saved, so that the power source is reduced in size, and the apparatus is also reduced in size.

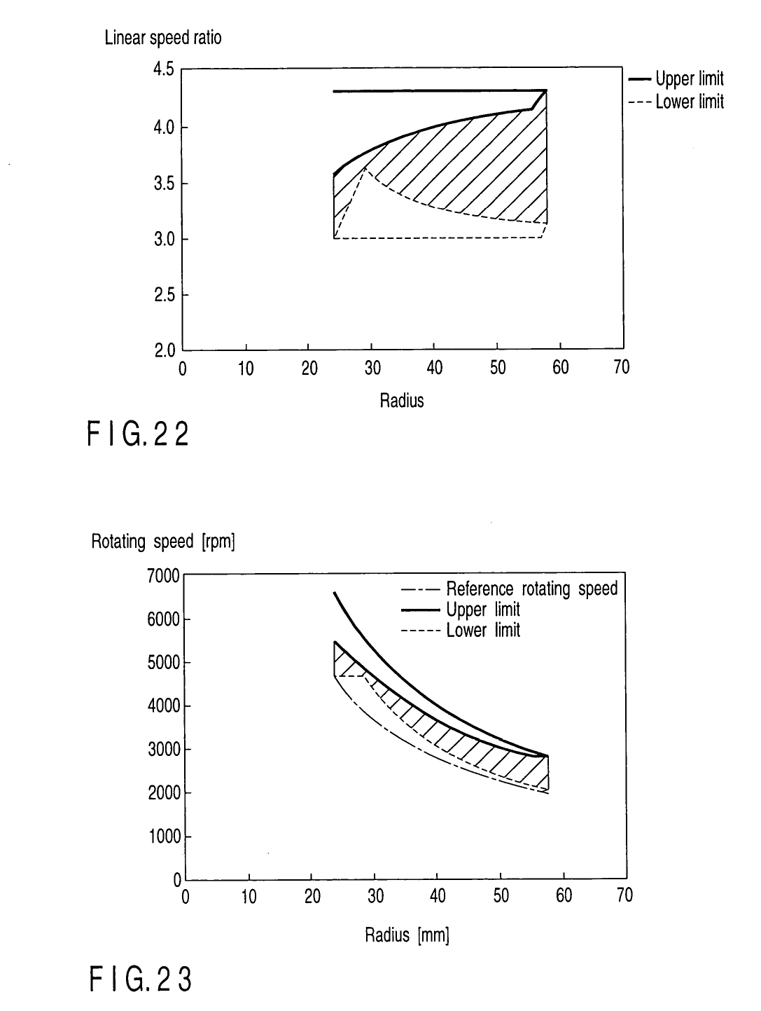

Next, a second embodiment of the present invention will be explained. In the first embodiment, the jumping direction in seamless reproduction is the positive direction in changing of the sector number only, but in this embodiment, jumping in the negative direction is also permitted. FIGS. 22 and 23 show the range of the target disk rotating speed of the optical disk device of the embodiment. In the first embodiment, jump is from the inner circumference to the outer circumference only in layer 0, and jump is from the outer circumference to the inner circumference only in layer 1. In this embodiment, on the other hand, jump occurs in two directions in each layer. In FIG. 19, the lower limit speed of layer 0 is over the upper limit speed of layer 1 in a certain radial region, and in this region, the target speed C for jumping in two directions cannot be set.

In this embodiment, in order to eliminate such a region, the upper limit reading rate LinBₘₐₓ is calculated to be 4.3× variable-speed. As known from FIGS. 22 and 22, there is no overlapping region, and at any radius, there is a region between the lower limit speed and the upper limit speed in jumping in the inner circumferential direction and outer circumferential direction, and the target speed C can be set. To guarantee reading at 3× variable-speed, it is enough to read at about 1.4 speeds only. In the case of the disk in the CAV system, at the outermost circumference, it is required to read at linear speed of about 7.5 times of the innermost circumference, but it is a great merit of this embodiment that the maximum linear speed can be lowered substantially. In this embodiment as well, it is not required to raise the maximum rotating speed of the spindle motor as compared with the CLV system of 3× variable-speed.

When the upper limit linear speed is slightly raised further to about 4.5 times, the minimum value of the upper limit linear speed at the entire radius is not lower than the lower limit linear speed, and the entire disk can be operated at a constant linear speed of about 3.65 times.

Operation of the disk at constant linear speed over the lower limit reading rate LinAₘᵢₙ is known also in the conventional DVD player as means for providing with various margins, but the true reason is not known. Although not guaranteed, as far as capable of reading, it is also attempted to read at constant reading rate in the DVD-ROM.

In the conventional DVD-Video, a device is assumed to complete rotating speed change of the spindle motor within jump during seamless reproduction, but such a limit is discarded in the present invention. Therefore, depending on the values of AccDisk or Sₘₐₓ, the rotating speed of the spindle motor determined by the embodiment may be nearly same as the conventional result, that is, the value of the conventional CLV system. Incidentally, if the upper limit speed LinBₘₐₓ can be set in a sufficiently large value, the CAV system is applicable same as in the case of reproduction of a conventional DVD-Video disk by means of a high speed DVD-ROM drive, and it is not required to increase the rotating speed of the spindle motor. Since the conventional limitation is alleviated in this system, the thus obtained result may be same as in the conventional operation depending on the condition. It is a feature of the embodiment that the results different from the mere CLV system or CAV system can be obtained. For example, if appearing to be a mere CLV system, the linear speed can be changed by the value of Sₘₐₓ. In the case of an optical disk of two or more layers, even if designed to set at a constant linear speed commonly to all layers, the speed C can be determined such that the linear speed is not be constant. For example, when reproducing a disk (or disk layer) possibly jumping from the outer circumference to the inner circumference during seamless reproduction, it may be designed to operate at a nearly constant angular velocity in the region near the innermost circumference, and operate at the lower linear speed as approaching the outer circumference at the outer circumference.

During jump in seamless reproduction, rotating speed change of the spindle motor may not be completed, and in this case the effect of the embodiment is increased as compared with the prior art. In addition, the effect of the target speed C set in the method of the embodiment is enhanced at less than the upper limit speed B free from target speed of constant rotating speed enabling the CAV operation. Further, in the case of an optical disk of two layers or more, even in the case capable of setting at constant linear speed commonly to all layers, the effect is further reinforced when the target speed C is determined such that the linear speed is not constant. For example, when reproducing a disk (or disk layer) having a case of jumping from the outer circumference to the inner circumference during seamless reproduction, in the region near the innermost circumference, it is designed to operate at a nearly constant angular velocity, or operate at a constant linear speed, or operate at an intermediate speed of the two, and in the further outer circumference, the linear speed drops to reach the target speed as going toward the outer circumference.

In the condition not having the region of constant linear speed common to each layer, the original target speed C peculiar to the embodiment is obtained. When applied to a single layer disk, a greater effect is obtained than the case of jumping from the outer circumference to the inner circumference during seamless reproduction. When jumping from the inner circumference to the outer circumference only, Cₘᵢₙ is a mere constant linear speed, and it is not so much different from the prior art.

The above explanation relates to a read-only disk, but the advantage of the embodiment is much greater when applied in a recordable optical disk. In a recordable disk, generally, when the recording speed is changed, the laser power and other conditions for recording must be changed, and the composition of a recording layer must be varied in consideration of fluctuations of the recording speed. However, it becomes difficult as the speed fluctuation range increases. It is hence often difficult to realize in the system accompanied by linear speed changes of about 2.5 times as in the CAV system. In this method, by contrast, since the changes of the linear speed are small, it is easier to realize.

Various timings may be considered for the timing of process of setting the target speed C shown in FIG. 17. For example, in the case where Sₘₐₓ or data outermost circumferential position is filed, the target speed C can be set when designing the optical disk. When the optical disk reproducing apparatus begins to reproduce an optical disk, various parameters may be read out and set, or when reproducing, target speeds Cₘₐₓ, Cₘᵢₙ may be calculated as required, and the target speed C may be determined on the basis of these values. Aside from the method of calculating the target speed C whenever required, the target speed C must be stored in the drive in any manner, and there are several methods for this purpose. For example, by expressing by the combination of the constant rotating speed curve and the constant linear speed curve, the program may be designed to select the curve at the time of operation, or the relation between the radius and the target speed may be stored as a table describing in a sufficiently small radius interval.

Further, the target is set as the rotating speed, but the control may be executed by converted into the reading linear speed instead of the rotating speed.

The embodiment, therefore, provides the following apparatus.

(1) An optical disk device for reproducing an optical disk having recorded therein a plurality of data to be read at not lower than a specific reading linear speed discretely at a predetermined interval or less, the optical disk device comprising:
means for determining any one of a minimum value of a disk rotating speed demanded at the current reading position and a minimum value of a disk rotating speed demanded at a second position remote from the current reading position by a predetermined distance, whichever the greater; and
target speed setting means for setting the rotating speed greater than the greater minimum value determined by the determining means as a target rotating speed at the current reading position.

(2) An optical disk device for reproducing an optical disk having recorded therein a plurality of data to be read at not lower than a specific reading linear speed discretely at a predetermined interval or less, the optical disk being required to jump the predetermined interval within a predetermined time Tj, the optical disk device comprising:
means for determining any one of a minimum value A of a disk rotating speed demanded at the current reading position and a minimum value B of a disk rotating speed demanded at a second position remote from the current reading position by a predetermined distance, whichever the greater; and
target speed setting means for setting, when the minimum value B is greater, any one of (the minimum value B−motor acceleration AccDisk×Tj) and the rotating speed A, whichever the greater, as the target rotating speed at the current reading position.

(3) An optical disk having recorded therein a plurality of data to be read at not lower than a specific reading linear speed discretely at a predetermined interval or less, wherein jumping within the predetermined interval is required when reproducing continuously, and data of the predetermined interval is recorded at a specific position on the disk.

(4) An optical disk having recorded therein a plurality of data to be read at not lower than a specific reading linear speed discretely at a predetermined interval or less, wherein jumping within the predetermined interval is required when reproducing continuously, and data of the predetermined interval is recorded as attribute information of the data.

(5) An optical disk device for reproducing an optical disk by varying a disk rotating speed depending on a radial position, wherein, when jumping in a direction of increasing the disk rotating speed, operation of a motor for changing the disk rotating speed is started after completion of operation of a feed motor for jumping.

In the optical disk devices of (1) and (2), even if the disk rotating speed does not follow up sufficiently to the target rotating speed until reading after jumping, the reading rate is guaranteed to be the minimum reading rate or higher.

In the optical disks of (3) and (4), the maximum jump distance can be set in each disk or each item of data, and by setting the smallest value depending on the content, the disk rotating speed can be suppressed to a required minimum limit, so that the noise can be suppressed and the power consumption can be saved in the optical disk device.

In the optical disk device of (5), when jumping, both the feed motor and spindle motor are accelerated or decelerated at the same time, increase of peak of power consumption can be avoided, and the power consumption can be saved without elongating the jump time.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

1-22. (canceled).

23. Sealing cap for screw closure of a receptacle for alcoholic beverages in the form of a bottle with a neck, equipped with sealing means and pilfer-proof means, comprising two assembled parts attached, in rotational and axial terms:
a) an inner part or insert, made of plastic, comprising an inner head and an inner skirt, with said inner head comprising sealing means and said inner skirt comprising inner threading on its inner surface intended to co-operate with threading of the neck, and
b) an outer part or cap made of metal or comprising a metal portion, enclosing and hiding at least said inner skirt, with the outer surface of said inner part and the inner surface of said outer part co-operating in view of the assembly of said inner and outer parts,
wherein the inner part comprises pilfer-proof means, with said inner skirt connected by bridges to a guarantee seal held by a ring of the neck and separated from said skirt after a first opening of said cap, said outer part carries all decorations of said cap, and comprises an outer skirt having a length sufficient to hide, at least before the first opening of said cap, said inner skirt and said guarantee seal, so as to be able to modify the appearance of said cap at will without having to modify any technical functions, with said guarantee seal becoming visible after the first opening,
wherein said guarantee seal comprises an inner ring equipped with fastening components turned towards the inside of said cap, and snapped under said ring such that, during the first opening, the bridges break, with said guarantee seal prevented from moving upwards by the co-operation of said components with said ring, and such that said guarantee seal, separated from the rest of said cap, becomes the visible proof of said first opening, and
wherein said outer skirt comprises bridges attaching it to an outer ring, with said outer ring being locked upwards by said inner ring, such that during the first opening, the outer and inner rings are separated from the rest of said cap.

24. Cap according to claim 23, wherein said outer part comprises an outer head.

25. Cap according to claim 23, wherein said outer part comprises a straight skirt.

26. Cap according to claim 23, wherein said outer part forms a rotation surface which is of a constant radius.

27. Cap according to claim 23, wherein said outer part and said inner part comprise mechanical or chemical attachment means, for said assembly to said inner part.

28. Cap according to claim 27, wherein the attachment means comprises gluing.

29. Cap according to claim 23, wherein said inner part is a polypropylene insert, equipped with inner threading on which the guarantee seal comprises clips.

30. Cap according to claim 23, wherein said outer part is made of surface treated aluminum which creates a metallic color or appearance.

31. Cap according to claim 30, wherein the surface treatment is brushing or anodizing.

32-33. (canceled).

34. Cap according to claim 23, wherein said outer ring is locked upwards by said inner ring by means of a lower rim of said outer ring.

35. Cap according to claim 23, wherein said sealing means comprises an added seal or a circular lip attached to said inner head.

36. Cap according to claim 35, further comprising an added seal of sufficient diameter to cover the edge of the neck and axial and/or radial compression means on the inner surface of said insert, to apply said seal in a tight manner onto said edge of said neck during closure.

37. Cap according to claim 36, wherein said axial compression means comprises a circular rib formed on the inner wall of said inner head for compressing said seal onto the upper part of said edge.

38. Cap according to claim 36, wherein said radial compression means comprises an annular extra thickness formed on said inner skirt or on said inner head for compressing said seal onto all or part of the curved part and/or onto the radial part of the edge.

39. Cap according to claim 38, wherein said annular extra thickness takes the form of an annular step positioned at the inner annular angle formed at the bridge of the inner head and the inner skirt.

40. Cap according to claim 36, wherein said inner head comprises an annular rim with a punched central part.

41. Cap according to claim 36, wherein:
said inner head has a thickness of from 0 to 0.5 mm,
said compression means comprises a curved part.

42. Cap according to claim 36, wherein the thickness of said compression means is selected as a function of the thickness Ej of the seal and the space Eo between said neck and said cap, such that said receptacle is closed in a tight manner by said cap.

43. Cap according to claim 36, wherein said axial and/or radial compression means is an integral part of said insert or forms an added part.

44. Cap according to claim 35, comprising holding means for said added seal.
